(19) United States
(12) Patent Application Publication
(10) Pub. No.: US 2015/0269263 A1
(43) Pub. Date: Sep. 24, 2015

(54) METHOD, SYSTEM, AND PROGRAM PRODUCT FOR CREATING REPORTS FOR INTELLECTUAL PROPERTY

(71) Applicant: Anthony De Andrade, Kihei, HI (US)

(72) Inventor: Anthony De Andrade, Kihei, HI (US)

(73) Assignee: Computer Software Associates, Inc., Kihei, HI (US)

(21) Appl. No.: 14/457,302

(22) Filed: Aug. 12, 2014

Related U.S. Application Data
(63) Continuation-in-part of application No. 14/223,985, filed on Mar. 24, 2014.

(51) Int. Cl. G06F 17/30; H04L 29/08; H04L 29/06

(52) U.S. Cl. CPC G06F 17/30867; H04L 67/42; H04L 67/10; H04L 67/06

(57) ABSTRACT

A method, system and program product comprise communicating, to a server, a user's request for a report comprising a name associated with a portfolio of patent applications, a first value indicating a time frame, and a second value indicating a period of time. The server is operable for using the name for extracting patent application data from databases to a second database and filtering the extracted data using the first value. The filtered data is organized by offices of filing, patent families, classifications, and status. Costs for patent applications associated with the filtered data are determined using the second value. Filing patterns are determined using the offices of filing and the patent families. Filing activity are determined using the classifications. Times to grant for the offices of filing are determined. At least one report is generated and received over the network.

### CROSS-REFERENCE TO RELATED APPLICATIONS

The present CIP Utility patent application claims priority benefit of the U.S. provisional patent for application for patent Ser. No. 61/805,905 entitled “Method, System, and Program Product for Creating Reports for Intellectual Property,” filed 27 Mar. 2013 and U.S. Utility patent application Ser. No. 14/223,985 entitled “Method, System, and Program Product for Creating Strategy Reports for Intellectual Property,” and filed 24 Mar. 2014 under 35 U.S.C. 111(a). The contents of these related applications are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

While some embodiments of the invention generally relate to data analysis; the invention more particularly generally relates to the analysis of public data and the generation of detailed reports.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Owners and/or managers of patent portfolios and other similar portfolios may seek efficient means and/or methods for analyzing and/or managing available data.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. One such aspect of the prior art shows methods and systems to provide flexible analysis of a portfolio of intellectual property assets. By way of educational background, another aspect of the prior art generally useful to be aware of teaches of a system and a method for monitoring and managing patent events. Another such aspect of the prior art discloses of systems and methods for the computerized management of patent information. However, these solutions may not provide adequate methods for analysis via reports that cater to an analyst's and/or managers ability to sort available public or otherwise available data into meaningful, simple category's, including, without limitation: searchable and sortable by family id, a list of expiring patents, a report of the current and projected maintenance costs associated with patents, the time for countries to grant patents, the number of ungranted patent applications in a given country, and the filing patterns of each country. Such a solution would enhance the analyst's and/or manager's ability to make decisions as to whether license or abandon a patent, the decision to pay annual maintenance and application fees. A solution which did so would be desirable.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of an exemplary sampling of data, in accordance with an embodiment of the present invention;

FIG. 2 is an illustration of exemplary calculated output data from received input, in accordance with an embodiment of the present invention;

FIG. 3 is an illustration of an exemplary method for converting received data, in accordance with an embodiment of the present invention;

FIG. 4 is an illustration of an exemplary method for organizing data structures, in accordance with an embodiment of the present invention;

FIG. 5 is an illustration of an exemplary method for analysis of a portfolio of data, in accordance with an embodiment of the present invention;

FIG. 6 is a block diagram depicting of an exemplary client/server system, which may be used by an exemplary web-enabled/networked embodiment of the present invention;

FIG. 7 illustrates a block diagram depicting a conventional client/server communication system;

FIG. 8 is a block diagram depicting an exemplary system, which may be used by an exemplary embodiment of the present invention;

FIGS. 9 and 9A-9F illustrate an exemplary analysis report of Ungranted Patent Applications, in accordance with an embodiment of the present invention, in which FIG. 9A is an illustration of an Ungranted Aging Report Summary, FIG. 9B is an illustration of an Ungranted Aging Report Category Summary, FIG. 9C is an illustration of an Ungranted Aging Report Detail, FIG. 9D is an illustration of an Ungranted Aging Report Category Detail, FIG. 9E is an illustration of an Ungranted Aging Report Detail by Family, and FIG. 9F is an illustration of the Ungranted Aging Report Category Detail by Family;

FIGS. 10 and 10A-10C illustrate an exemplary analysis report of filing patterns in patent applications, in accordance with an embodiment of the present invention, in which FIG. 10A is an illustration of a Filing-Patterns Report, FIG. 10B is an illustration of a Filing-Patterns-Analysis Country-Summary Report (sorted by country), and FIG. 10C is an illustration of a Filing-Patterns-Analysis Country-Summary Report (sorted by relative percentage), in accordance with an embodiment of the present invention;

FIGS. 11 and 11A-11F an exemplary analysis report of expiring patent applications, in accordance with an embodiment of the present invention, in which FIG. 11A is an illustration of an Expiring-Patents Report Summary, FIG. 11B is an illustration of an Expiring-Patents Report Category Summary, FIG. 11C is an illustration of an Expiring-Patents Report Detail, FIG. 11D is an illustration of an Expiring-Patents Report Category Detail, FIG. 11E is an illustration of an Expiring-Patents Report Detail by Family, and FIG. 11F is an illustration of an Expiring-Patents Report Category Detail by Family, in accordance with an embodiment of the present invention;

FIG. 12 is an illustration of an exemplary analysis report of the classification of patent applications, in accordance with an embodiment of the present invention;

FIGS. 13 and 13A-13C illustrate an exemplary analysis report of the time to grant patent applications, in accordance with an embodiment of the present invention, in which FIG. 13A is an illustration of a Time to Grant Analysis, by country, FIG. 13B is an illustration of a Time to Grant Analysis, first by country and then by the classification group of applications within the country, and FIG. 13C is an illustration of a Time to Grant Analysis, first by classification group and then by country, in accordance with an embodiment of the present invention; and

FIG. 14 shows a flowchart of an exemplary method for generating Ungranted Aging Report, in accordance with an embodiment of the present invention.

Unless otherwise indicated, illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation of any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

Some embodiments of the present invention may provide means and/or methods for storage, analysis, and/or management of data. In some of these embodiments, data may be provided by users and/or received from external software. In a non-limiting example, data may be patent information received from online patent databases.

Many embodiments may provide means and/or methods for reconstructing patent portfolios via import of publicly available data. Some of these embodiments may use publicly available data to inform users in a variety of ways, including, without limitation, what patent filing strategies a party may have used in practice (e.g. as reflected in previously filed patent applications), potential future costs a competitor may face based on public patent filing data, filing strategies by competitors (e.g. countries competitors file in, how often, location of initial filings, changes over time, etc.), active patents owned by a party which party may prefer to abandon and/or license out, payments of ongoing maintenance fees of application which may be pending longer than average, etc. Currently available solutions may not provide such information as may embodiments of the present invention.

FIG. 1 is an illustration of an exemplary sampling of data, in accordance with an embodiment of the present invention. In the present embodiment, system may receive various information about a patent, including, without limitation, application authority 105, application filing date 110, application number 115, publication authority 120, and first grant date 125. Further, in the present embodiment, data may include multiple filings 130, or family members, of a given patent. In a non-limiting example, patent data may be collected from EPO databases and/or other official databases. In some embodiments, collected data may be from a variety of sources. In a non-limiting example, software may combine data from various tables of a patents family information.

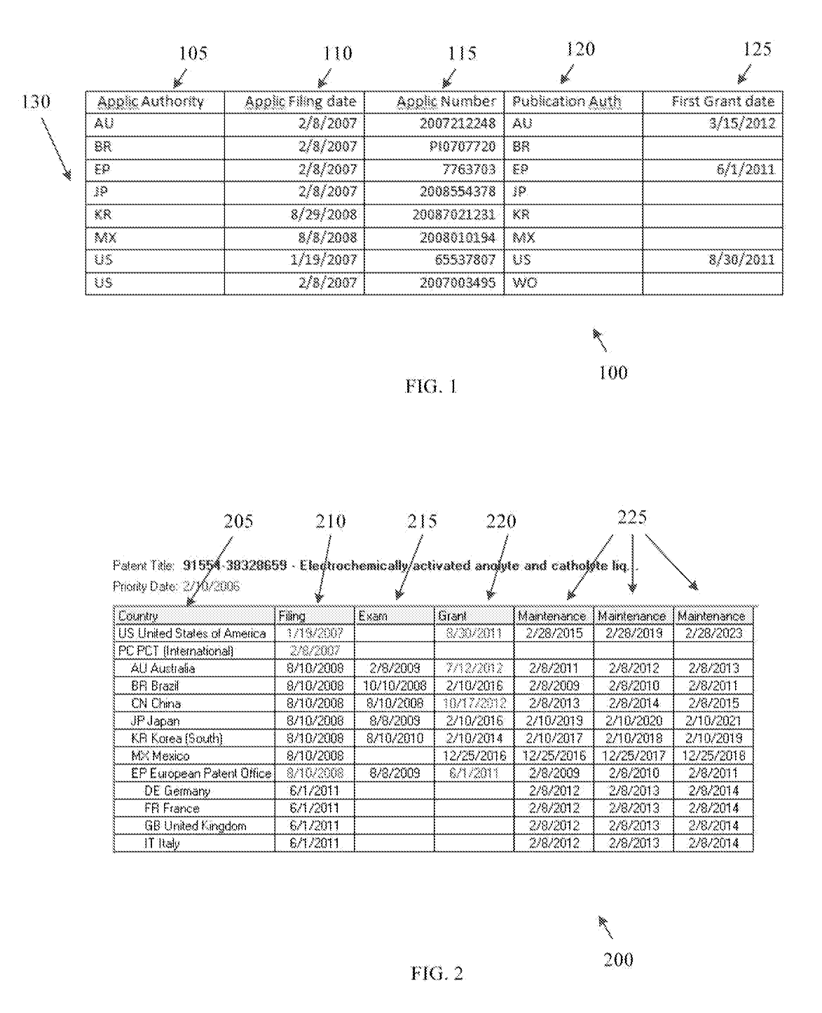

FIG. 2 is an illustration of exemplary calculated output data from received input shown in FIG. 1, in accordance with an embodiment of the present invention. In the present embodiment, system may output various calculated patent data, including, without limitation, filing country 205, filing date 210, examination date 215, grant date 220, and maintenance dates 225. In some embodiments, system may use logic and/or stored data to uncover “buried” information in a sampling of data. In a non-limiting example, a system may determine that a patent application may have first been filed via WO, then EP via WO. In the present example, this determination may be made via the same application filing date supplied for a WO or EP application in the same family, reinforced by cross-row use of the WO or EP application's application ID. In another non-limiting example, a system may uncover associated applications, e.g. DE, FR, GB, and IT applications in FIG. 2. In many embodiments, system may provide timeline information from received input. In a non-limiting example, a system may uncover filing and/or other dates from received Patstat data. In another non-limiting example, a system may use stored data, such as “typical time to grant” data to determine approximate dates. In still another non-limiting example, a system may use stored country-specific rules to determine maintenance payment dates. In some embodiments, system may extract application-specific data, including, without limitation, number of pages in application, number of claims, etc., using public databases and/or Patstat data. In other embodiments, system may calculate costs, such as, without limitation, cost of filing, grant, maintenance, etc., using stored, researched and/or proprietary fee rules for each country.

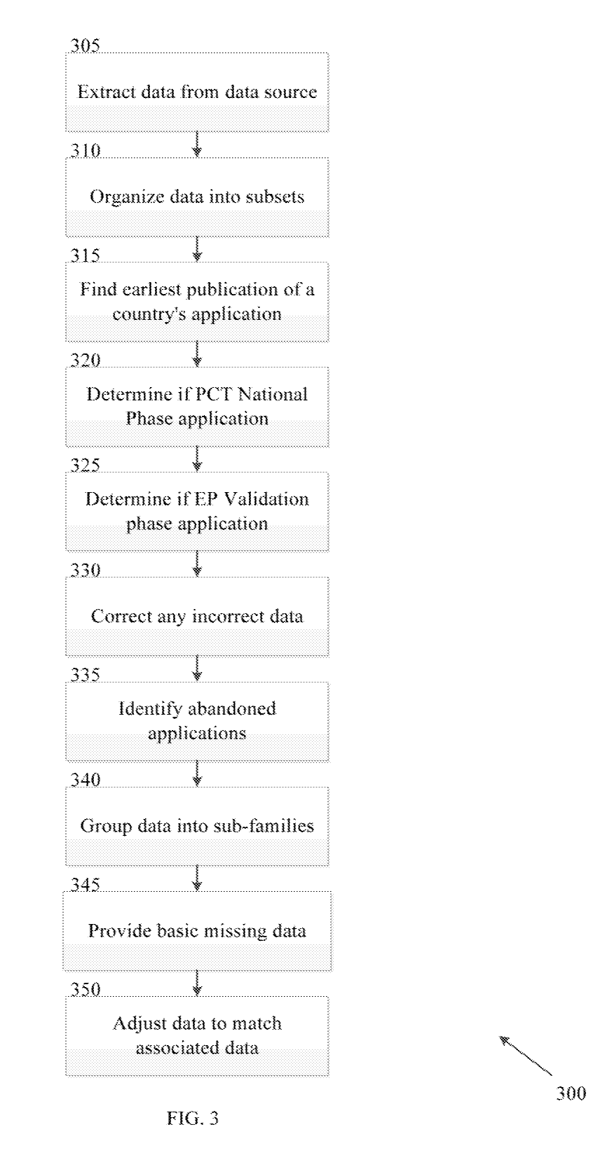

FIG. 3 is an illustration of an exemplary method for converting received data, in accordance with an embodiment of the present invention. In the present embodiment, system may extract data from a source in a step 305. In a non-limiting example, a system may receive public patent data from an EPO, Patstat, and/or DOCDB database. The EPO Patstat and DOCDB databases may be stored and accessed on local servers, and updated as updates are released. Other patent information databases supplied by other official offices may be either stored and accessed on local servers or accessed via an online query. In some embodiments, system my load received data onto local servers. In many embodiments, system may extract specific data from received data. In a non-limiting example, a system may extract data for a particular patent applicant and/or set of applicants. In the present embodiment, system may organize extracted data into subsets in a step 310. In a non-limiting example, application information for a particular applicant may be grouped into single applications to each given application authority and/or country of filing. In the present example, the SQL used may use fuzzy logic to find mis-spelled names and skip similar names for unrelated entities. In some embodiments, data may be organized in any order. In a non-limiting example, multiple publications of a single patent application may be processed by system starting with an earliest filing date. In the present embodiment, system may determine the earliest publication among publications associated with a given country's application, and use that publication's data for basic data fields, such as filing date, in a step 315. Further, in the present embodiment, system may determine that certain countries' applications were filed as National Phase applications after processing as a PCT Application in a step 320. In a non-limiting example, system may use a WO application's “application ID” to classify an application as a PCT National Phase application. In the present embodiment, system may determine that certain countries' applications were filed as EPO Validation phase applications after EPO grant in a step 325. In a non-limiting example, system may use an EP application's “application ID” to classify an application as an EPO Validation phase application. In the present embodiment, system may correct any incorrect data in a step 330. In a non-limiting example, a system may correct occasional incorrect DOCDB family values based on any associated EP and/or WO parent application. In the present embodiment, system may identify abandoned applications in a step 335. In a non-limiting example, a system may identify possible abandoned applications using any or all associated application publications and/or legal event data. In the present embodiment, system may group data into sub-families in a step 340. In a non-limiting example, a system may group countries into sub-families based on associated WO and/or EP patent applications. In the present embodiment, system may provide any basic missing data in a step 345. In a non-limiting example, a system may create new rows for applications which may not have their own application publications based on legal event data for associated EP and/or WO parent applications. In the present non-limiting example, the system may insert appropriate basic data for such added rows, such as, without limitation, family IDs, title, file date, etc. In the present embodiment, system may adjust data to match and/or agree with any associated data in a step 350. In a non-limiting example, a system may reset file dates to match associated EP and/or WO parent applications.

In some embodiments, data extraction and/or conversion processes may result in individual sets of data. In a non-limiting example, a process may result in one set of data for each application to application authority and/or country of filing which may contain a selected applicant's name. In many embodiments, a system may create data tables and/or other display format with a structure which may be conducive to creating analyses and/or reports. In a non-limiting example, a “portfolio cost analyzer” (PCA) may be an embodiment of software which may utilize data tables from converted data.

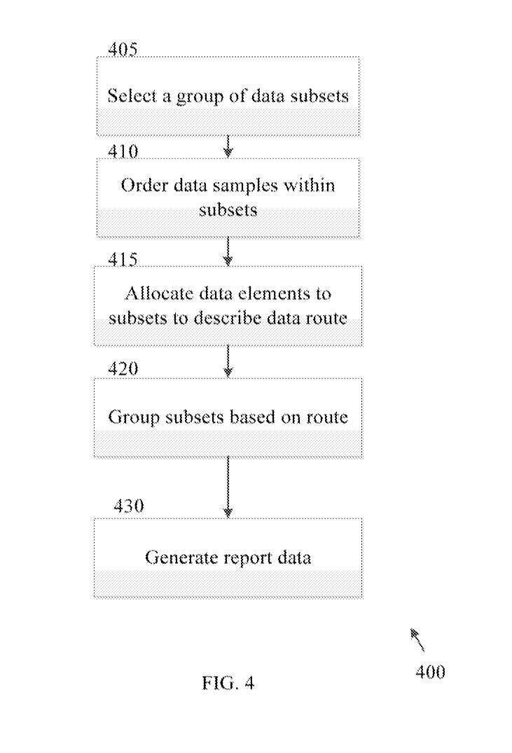

FIG. 4 is an illustration of an exemplary method for organizing data structures, in accordance with an embodiment of the present invention. In some embodiments, data structures may be organized within PCA. In the present embodiment, system and/or a user may select a group of data subsets which may comprise a “family” in a step 405. In some embodiments, each data subset may correspond to a specific designation. In a non-limiting example, each patent application in a given country may comprise one data subset, with a group of data subsets being a data family. In the present non-limiting example, the family may be represented by rows for each country represented by a data subset such as, but not limited to, US, WO, AU, EP, DE, US, EP, DE. In the present embodiment, system may determine an order for data samples within data subsets in a step 410. In a non-limiting example, patent data may have indicators that a patent application may have been initially filed to US, then to PCT, then AU, EP via PCT, DE via EP, then a divisional to US, and then to EP and another DE. In some embodiments, indicators may be clear such as, but not limited to, a particular application having the earliest filing date. In other embodiments, indicators may be determinable through logic. In the present embodiment, system may allocate one or more data elements to a data subset to describe its data “route” in a step 415. In a non-limiting example, a system may allocate three data elements to a patent application to describe its route. In the present non-limiting example, the three data elements may be as follows: route 1 ccode; route 2 ccode; route 3 ccode. In some embodiments, “ccode” may refer to a standard 2-position country code used for countries by e.g. WIPO. In the present embodiment, system may group data subsets based on route in a step 420. In a non-limiting example, a family of patent applications may be grouped into a “main family” and a “sub-family”. In the present non-limiting example and utilizing information from above examples, the main family may be comprised of 5 rows: US, XX (dummy ccode), XX with an indicator that this is initial ccode of family and/or sub-family; WO, XX, XX; WO, AU, XX; WO, EP, XX; WO, EP, DE. The ‘XX’ present in the second or third positions makes it easier for later program logic to do analysis and produce reports (e.g., to calculate filing counts by country per route, and to calculate filing percentages). In the present embodiment, filing strategy reports may be generated using the route information in a step 430. These reports may provide, but not limited to percentages of times each country was initial country; percentage of times PCT route was chosen; percentage of times filings were done to various countries; percentage of times filings were abandoned, and the timings of abandonments. Further, in the present non-limiting example, the sub-family may be comprised of 3 rows: US, XX, XX; EP, XX, XX; EP, DE, XX. In some embodiments, a row of data may have associated data, including, without limitation, filing date, examination date, grant date, maintenance dates, number of claims in application, number of pages in application, etc.

In some embodiments, a PCA may be a computer program which may predict and/or analyze costs for an entire portfolio of data. In a non-limiting example, data may be patents and/or patent applications. In the present non-limiting example, a patent family may comprise any number of countries. Further, in the present non-limiting example, a patent family may comprise applications via PCT and/or EPO.

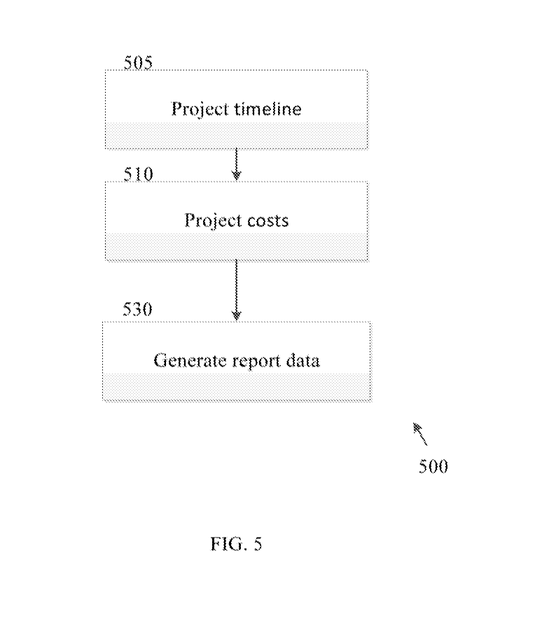

FIG. 5 is an illustration of an exemplary method for analysis of a portfolio of data, in accordance with an embodiment of the present invention. In the present embodiment, software may project timeline information in a step 505. In a non-limiting example, for each country in each patent family, software may project dates for when each stage may occur. In the present embodiment, software may project costs for any stages in lifetime of data portfolio in a step 510. In a non-limiting example, for each country in each patent family, software may project costs for each stage of acquiring and/or maintaining patents. In the present non-limiting example, projection may be based on particular attributes of patents, e.g. number of claims, etc. Further, in the present non-limiting example, costs may include, without limitation, official fees and local associate charges, and stages may include, without limitation, filing, examination, prosecution, grant, maintenance (annuities), etc. In some embodiments, cost analysis may be based on external fee information. In a non-limiting example, software may determine patent costs through accessing fee schedules from a number of associates in each country as well as data on official fees from a governmental patent office in each country. In some embodiments, software may categorize a patent family by its international classification. In some of these embodiments, software may perform portfolio analysis across any selected classification and/or any combination of classifications. In at least one embodiment, analysis may provide costs totaled over any length of time, including, without limitation, one year, one quarter, one month, etc. In a step 530, one or more reports may be generated form data produced in steps 505 and 510.

In some embodiments, software may generate a variety of reports showing various calculated data. In one embodiment, software may generate an application classification report. In a non-limiting example, an application classification report may show a number of applications by a company within each international classification and/or sub-classification. In another embodiment, software may generate a report of a time-to-grant analysis. In a non-limiting example, a time-to-grant report may be available by international classification at various levels. In many currently available systems, actual historic time-to-grant for granted patent applications may not be readily available for review and/or to predict future times to grant for a given company.

In one or more embodiments, software may generate a filing pattern analysis. In some of these embodiments, software may analyze patent applications filed in any specified range of dates. In a non-limiting example, software may output filing pattern analysis data into two groups: filing patterns and country summary.

In a non-limiting example, for each possible country of initial application, a filing pattern group may show an average number of times per year that such an initial application may have been filed, and may then present an analysis of subsequent filings to other countries. In the present non-limiting example, analysis may include, without limitation: direct filings, including names of countries and percent of times filed in each country (i.e. not via PCT or EPO); subsequent filings to PCT each year on average, including names of countries and associated percentages (i.e. via PCT); subsequent applications to EPO or EPO via PCT each year on average, including names of countries and associated percentages (i.e. via EPO); continuation/divisional applications filed per year on average, including names of countries and associated percentages.

In another non-limiting example, a country summary group may show countries filed to, number of filings, average number per year, and a relative percentage of such filings (e.g. relative to number of filings overall). In the present non-limiting example, software may sort list by country and/or relative percentage.

In some embodiments, software may generate a report of expiring patents. In a non-limiting example, a report may examine maintenance/annuity costs for granted patents which may be due to expire in a given amount of time, such as, without limitation, 5 years. In the present non-limiting example, report may serve as a tool that for any selected countries and/or selected granted patents may help users decide whether to continue paying fees and/or whether to license a patent. In some embodiments, report of expiring patents may be displayed in one or more groups, including, without limitation, summary, category summary, detail, and category detail. In a non-limiting example, a summary sheet may show amount totals for each country with expiring patents. In the present non-limiting example, totals may be shown for each of a given number of coming years, and may be sorted in decreasing order of a total for a country. Further, in the present non-limiting example, summary sheet may also show count of such patents in each country. In another non-limiting example, a category summary sheet may break down amounts for each country into official fees and/or associate fees. In still another non-limiting example, a detail sheet may show amounts for each year for each patent in each country. In the present non-limiting example, detail sheet may enable a patent-by-patent review in each applicable country. Further, in the present non-limiting example, detail sheet may be sorted by patent parent filing date and/or country for each patent. In another non-limiting example, a category detail sheet may show detail amounts broken down by official fees and/or associate charges. In some alternate embodiments, other parameters may be used for sorting the sheets. In some other alternate embodiments, a user may choose the parameters for sorting.

In one or more embodiments, software may generate a report of ungranted aging. In a non-limiting example, software may locate ungranted applications in a portfolio and may determine whether such applications may have not been granted for longer than ‘X’ amount of time. In the present non-limiting example, X may be a typical time to grant for a given country. Further, in the present non-limiting example, report may accumulate yearly maintenance payments being made for each such application. In some of these embodiments, ungranted aging report may be displayed in one or more groups, including, without limitation, summary, category summary, detail, and category detail.

In at least one embodiment, software may generate a report of a detailed cost analysis. In a non-limiting example, a detailed cost analysis may be similar to PCA reports, with minor adaptations for use with public data.

Some embodiments of the present invention may use data from a variety of sources. In a non-limiting example, a first data collection may have patent application and status data, including, without limitation, filing date, country filed to, number of claims in applications, grant date (if any), maintenance payment dates (if any), family information, etc. In the present non-limiting example, suitable sources for first data collection may be EPO's DOCDB and/or INPADOC databases, or a particular company's patent docketing system. In another non-limiting example, a second data collection may analyze and/or convert data from first data collection to a format which may allow for generation of reports discussed. Some embodiments of conversion process may be novel in its methods of converting, organizing, and/or connecting individual country applications, as well as in its complex logic for organizing patent applications in a way suitable for analysis. In another non-limiting example, a third data collection may include, without limitation, patent prosecution cost data and/or fee rules for each country. In the present non-limiting example, system may collect data from official patent offices around the world, as well as patent prosecution practitioners worldwide.

In some alternative embodiments, system may be suitable to perform keyword searches through patent databases. In a non-limiting example, a system may search a patent database for patents applied for by a particular inventor, and then perform various analysis on such patents.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

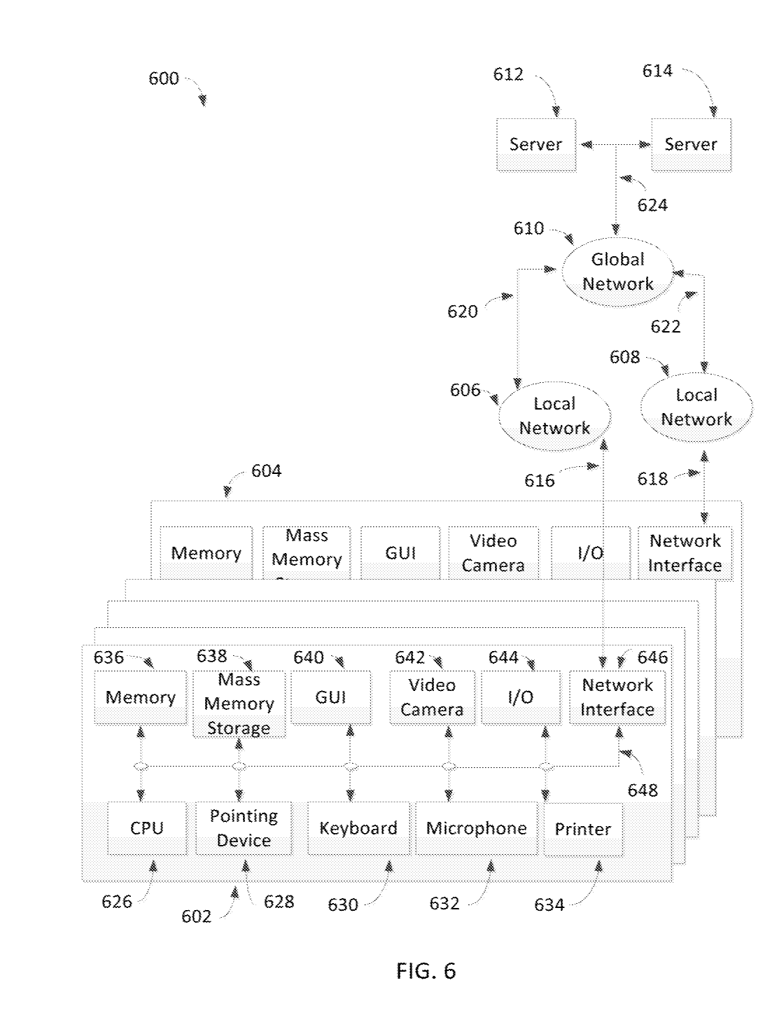

FIG. 6 is a block diagram depicting an exemplary client/server system which may be used by an exemplary web-enabled/networked embodiment of the present invention.

A communication system 600 includes a multiplicity of clients with a sampling of clients denoted as a client 602 and a client 604, a multiplicity of local networks with a sampling of networks denoted as a local network 606 and a local network 608, a global network 610 and a multiplicity of servers with a sampling of servers denoted as a server 612 and a server 614.

Client 602 may communicate bi-directionally with local network 606 via a communication channel 616. Client 604 may communicate bi-directionally with local network 608 via a communication channel 618. Local network 606 may communicate bi-directionally with global network 610 via a communication channel 620. Local network 608 may communicate bi-directionally with global network 610 via a communication channel 622. Global network 610 may communicate bi-directionally with server 612 and server 614 via a communication channel 624. Server 612 and server 614 may communicate bi-directionally with each other via communication channel 624. Furthermore, clients 602, 604, local networks 606, 608, global network 610 and servers 612, 614 may each communicate bi-directionally with each other.

In one embodiment, global network 610 may operate as the Internet. It will be understood by those skilled in the art that communication system 600 may take many different forms. Non-limiting examples of forms for communication system 600 include local area networks (LANs), wide area networks (WANs), wired telephone networks, wireless networks, or any other network supporting data communication between respective entities.

Clients 602 and 604 may take many different forms. Non-limiting examples of clients 602 and 604 include personal computers, personal digital assistants (PDAs), cellular phones and smartphones.

Client 602 includes a CPU 626, a pointing device 628, a keyboard 630, a microphone 632, a printer 634, a memory 636, a mass memory storage 638, a GUI 640, a video camera 642, an input/output interface 644 and a network interface 646.

CPU 626, pointing device 628, keyboard 630, microphone 632, printer 634, memory 636, mass memory storage 638, GUI 640, video camera 642, input/output interface 644 and network interface 646 may communicate in a unidirectional manner or a bi-directional manner with each other via a communication channel 648. Communication channel 648 may be configured as a single communication channel or a multiplicity of communication channels.

CPU 626 may be comprised of a single processor or multiple processors. CPU 626 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 636 is used typically to transfer data and instructions to CPU 626 in a bi-directional manner. Memory 636, as discussed previously, may include any suitable computer-readable media, intended for data storage, such as those described above excluding any wired or wireless transmissions unless specifically noted. Mass memory storage 638 may also be coupled bi-directionally to CPU 626 and provides additional data storage capacity and may include any of the computer-readable media described above. Mass memory storage 638 may be used to store programs, data and the like and is typically a secondary storage medium such as a hard disk. It will be appreciated that the information retained within mass memory storage 638, may, in appropriate cases, be incorporated in standard fashion as part of memory 636 as virtual memory.

CPU 626 may be coupled to GUI 640. GUI 640 enables a user to view the operation of computer operating system and software. CPU 626 may be coupled to pointing device 628. Non-limiting examples of pointing device 628 include computer mouse, trackball and touchpad. Pointing device 628 enables a user with the capability to maneuver a computer cursor about the viewing area of GUI 640 and select areas or features in the viewing area of GUI 640. CPU 626 may be coupled to keyboard 630. Keyboard 630 enables a user with the capability to input alphanumeric textual information to CPU 626. CPU 626 may be coupled to microphone 632. Microphone 632 enables audio produced by a user to be recorded, processed and communicated by CPU 626. CPU 626 may be connected to printer 634. Printer 634 enables a user with the capability to print information to a sheet of paper. CPU 626 may be connected to video camera 642. Video camera 642 enables video produced or captured by user to be recorded, processed and communicated by CPU 626.

CPU 626 may also be coupled to input/output interface 644 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 626 optionally may be coupled to network interface 646 which enables communication with an external device such as a database or a computer or telecommunications or internet network using an external connection shown generally as communication channel 616, which may be implemented as a hardwired or wireless communications link using suitable conventional technologies. With such a connection, CPU 626 might receive information from the network, or might output information to a network in the course of performing the method steps described in the teachings of the present invention.

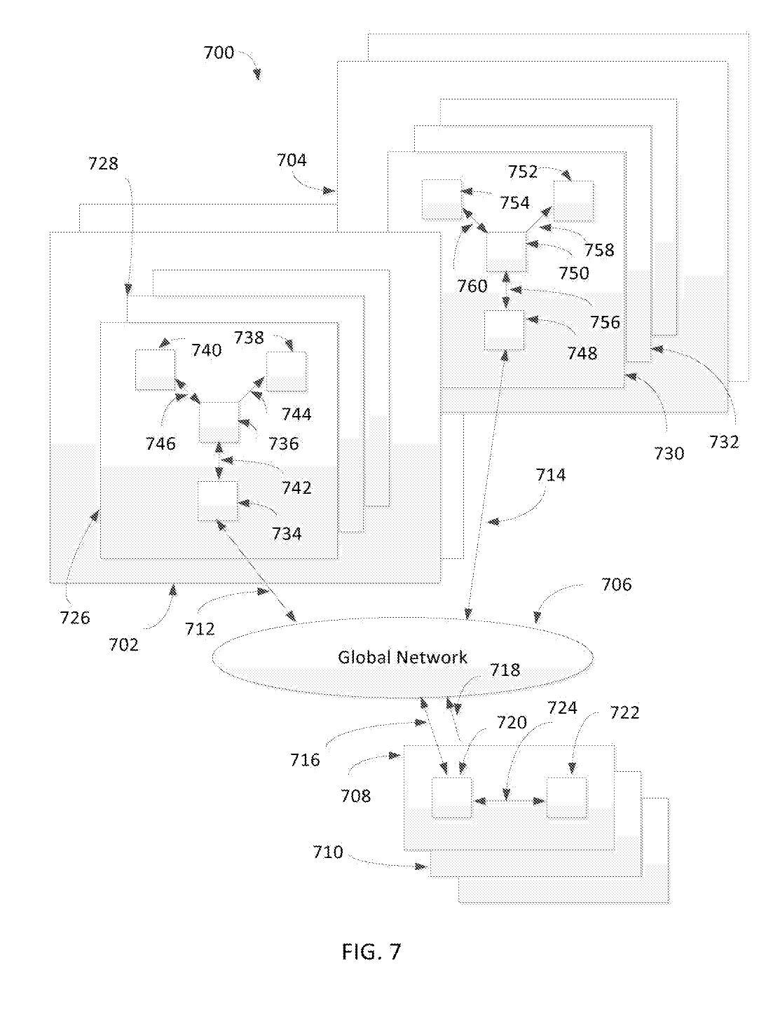

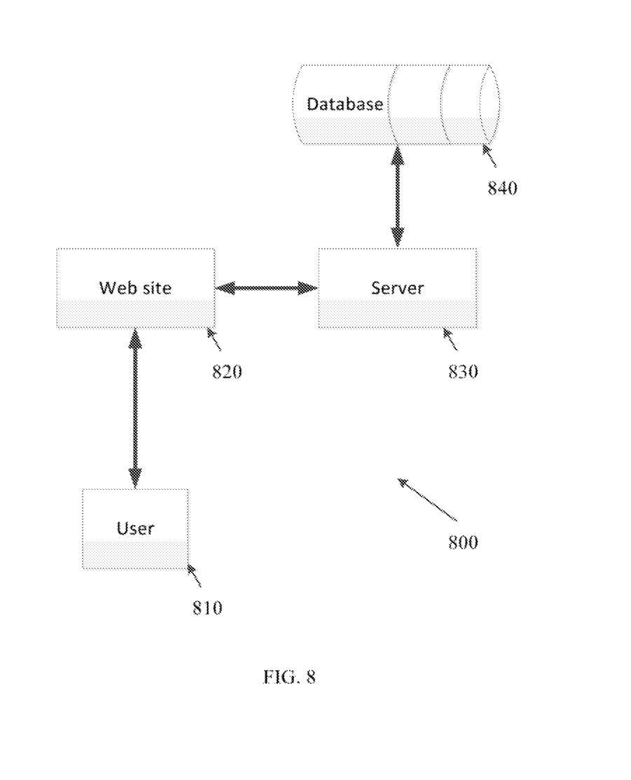

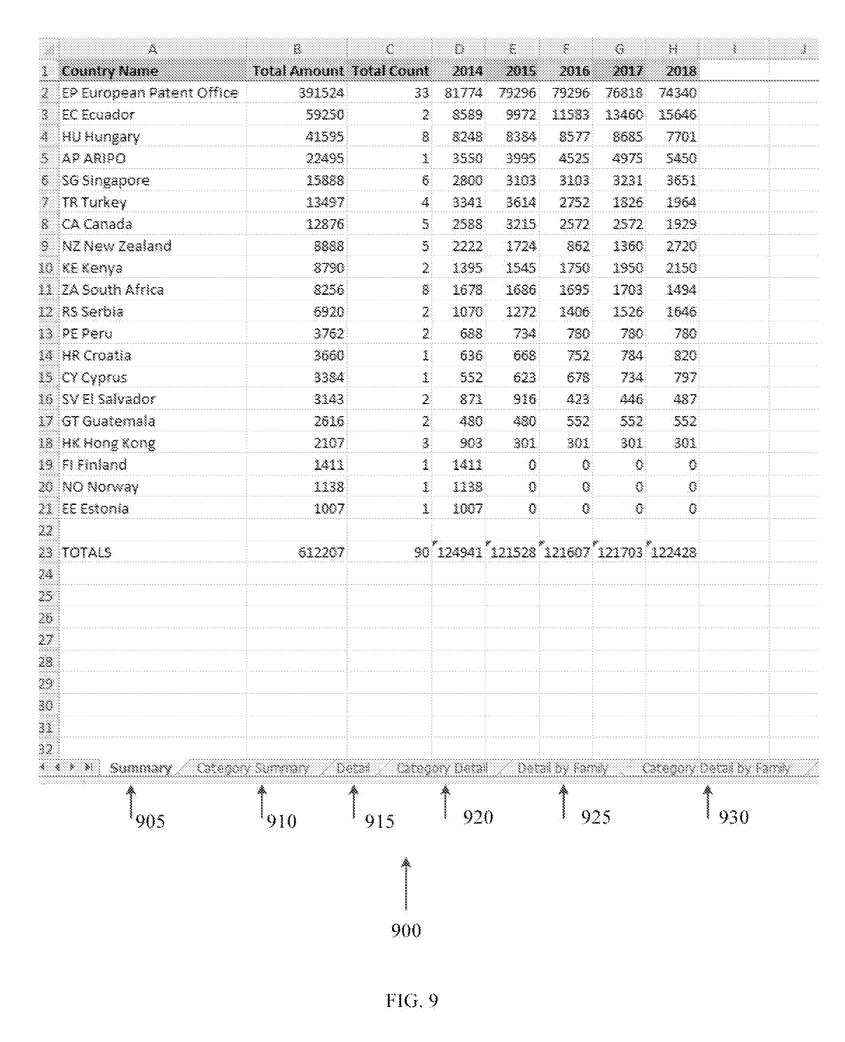

FIG. 7 illustrates a block diagram depicting a conventional client/server communication system.

A communication system 700 includes a multiplicity of networked regions with a sampling of regions denoted as a network region 702 and a network region 704, a global network 706 and a multiplicity of servers with a sampling of servers denoted as a server device 708 and a server device 710.

Network region 702 and network region 704 may operate to represent a network contained within a geographical area or region. Non-limiting examples of representations for the geographical areas for the networked regions may include postal zip codes, telephone area codes, states, counties, cities and countries. Elements within network region 702 and 704 may operate to communicate with external elements within other networked regions or within elements contained within the same network region.

In some implementations, global network 706 may operate as the Internet. It will be understood by those skilled in the art that communication system 700 may take many different forms. Non-limiting examples of forms for communication system 700 include local area networks (LANs), wide area networks (WANs), wired telephone networks, cellular telephone networks or any other network supporting data communication between respective entities via hardwired or wireless communication networks. Global network 706 may operate to transfer information between the various networked elements.

Server device 708 and server device 710 may operate to execute software instructions, store information, support database operations and communicate with other networked elements. Non-limiting examples of software and scripting languages which may be executed on server device 708 and server device 710 include C, C++, C# and Java.

Network region 702 may operate to communicate bi-directionally with global network 706 via a communication channel 712. Network region 704 may operate to communicate bi-directionally with global network 706 via a communication channel 714. Server device 708 may operate to communicate bi-directionally with global network 706 via a communication channel 716. Server device 710 may operate to communicate bi-directionally with global network 706 via a communication channel 718. Network region 702 and 704, global network 706 and server devices 708 and 710 may operate to communicate with each other and with every other networked device located within communication system 700.

Server device 708 includes a networking device 720 and a server 722. Networking device 720 may operate to communicate bi-directionally with global network 706 via communication channel 716 and with server 722 via a communication channel 724. Server 722 may operate to execute software instructions and store information.

Network region 702 includes a multiplicity of clients with a sampling denoted as a client 726 and a client 728. Client 726 includes a networking device 734, a processor 736, a GUI 738 and an interface device 740. Non-limiting examples of devices for GUI 738 include monitors, televisions, cellular telephones, smartphones and PDAs (Personal Digital Assistants). Non-limiting examples of interface device 740 include pointing device, mouse, trackball, scanner and printer. Networking device 734 may communicate bi-directionally with global network 706 via communication channel 712 and with processor 736 via a communication channel 742. GUI 738 may receive information from processor 736 via a communication channel 744 for presentation to a user for viewing. Interface device 740 may operate to send control information to processor 736 and to receive information from processor 736 via a communication channel 746. Network region 704 includes a multiplicity of clients with a sampling denoted as a client 730 and a client 732. Client 730 includes a networking device 748, a processor 750, a GUI 752 and an interface device 754. Non-limiting examples of devices for GUI 738 include monitors, televisions, cellular telephones, smartphones and PDAs (Personal Digital Assistants). Non-limiting examples of interface device 740 include pointing devices, mousse, trackballs, scanners and printers. Networking device 748 may communicate bi-directionally with global network 706 via communication channel 714 and with processor 750 via a communication channel 756. GUI 752 may receive information from processor 750 via a communication channel 758 for presentation to a user for viewing. Interface device 754 may operate to send control information to processor 750 and to receive information from processor 750 via a communication channel 760.

For example, consider the case where a user interfacing with client 726 may want to execute a networked application. A user may enter the IP (Internet Protocol) address for the networked application using interface device 740. The IP address information may be communicated to processor 736 via communication channel 746. Processor 736 may then communicate the IP address information to networking device 734 via communication channel 742. Networking device 734 may then communicate the IP address information to global network 706 via communication channel 712. Global network 706 may then communicate the IP address information to networking device 720 of server device 708 via communication channel 716. Networking device 720 may then communicate the IP address information to server 722 via communication channel 724. Server 722 may receive the IP address information and after processing the IP address information may communicate return information to networking device 720 via communication channel 724. Networking device 720 may communicate the return information to global network 706 via communication channel 716. Global network 706 may communicate the return information to networking device 734 via communication channel 712. Networking device 734 may communicate the return information to processor 736 via communication channel 742. Processor 746 may communicate the return information to GUI 738 via communication channel 744. User may then view the return information on GUI 738.

FIG. 8 is a block diagram depicting an exemplary system which may be used by an exemplary embodiment of the present invention.

User 810 may communicate bi-directionally with web site 820. Typically, user 810 may communicate using any compatible browser. In some embodiments, user 810 may communicate using a specialized application or app. In the present embodiment, web site 820 may present an interface that explains what reports are about, how the reports are generated, shows examples of reports, has functionality for the user to choose and pay for reports, and other functionalities. The user's choices are communicated from web site 820 to server 830. Server 830 may process the user's requests by querying one or more databases 840 and generating the chosen reports in accordance with the teachings of the present invention. Server 830 may then transfer the generated reports to web site 820. User 810 may access the generated reports on web site 820 for viewing and/or downloading. In the present embodiment, databases 840 are collocated with server 830. In some alternate embodiments, databases 840 may be remotely located. In some alternate embodiments, databases 840 may be located in a cloud storage system where other servers operating in accordance with the teachings of the present invention may access them.

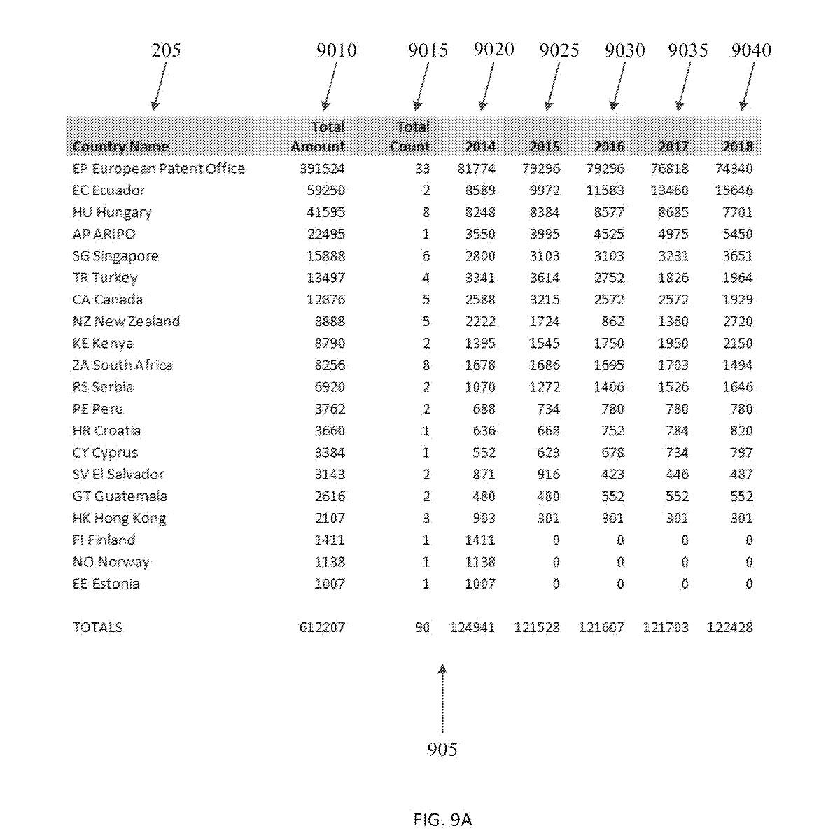

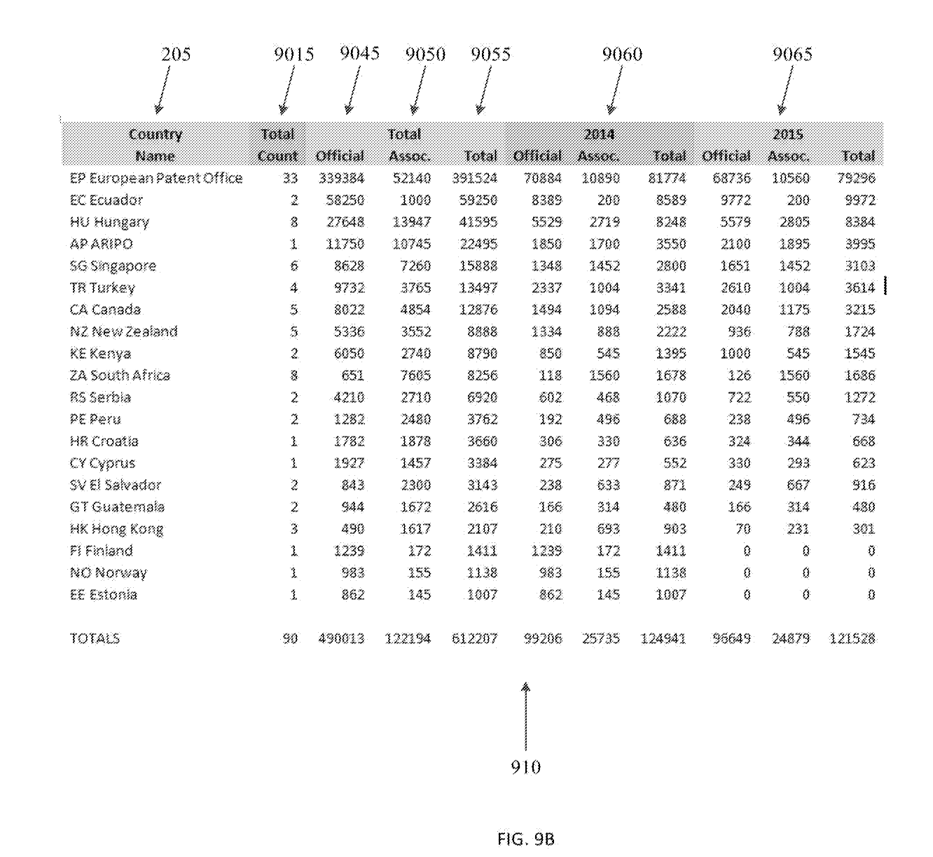

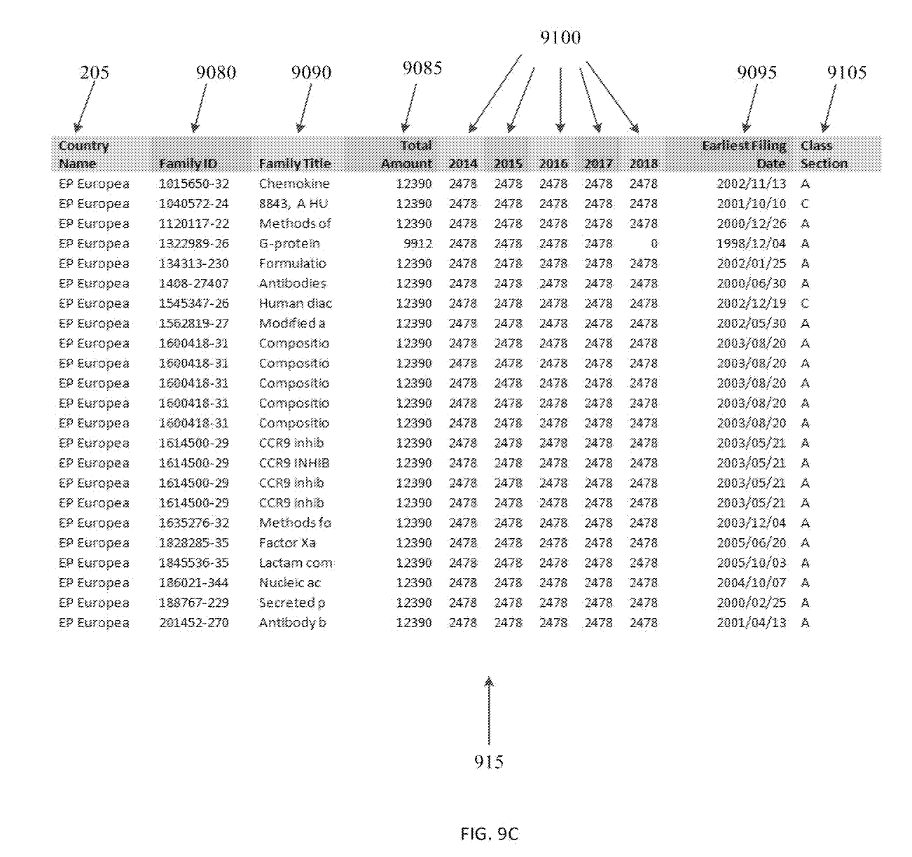

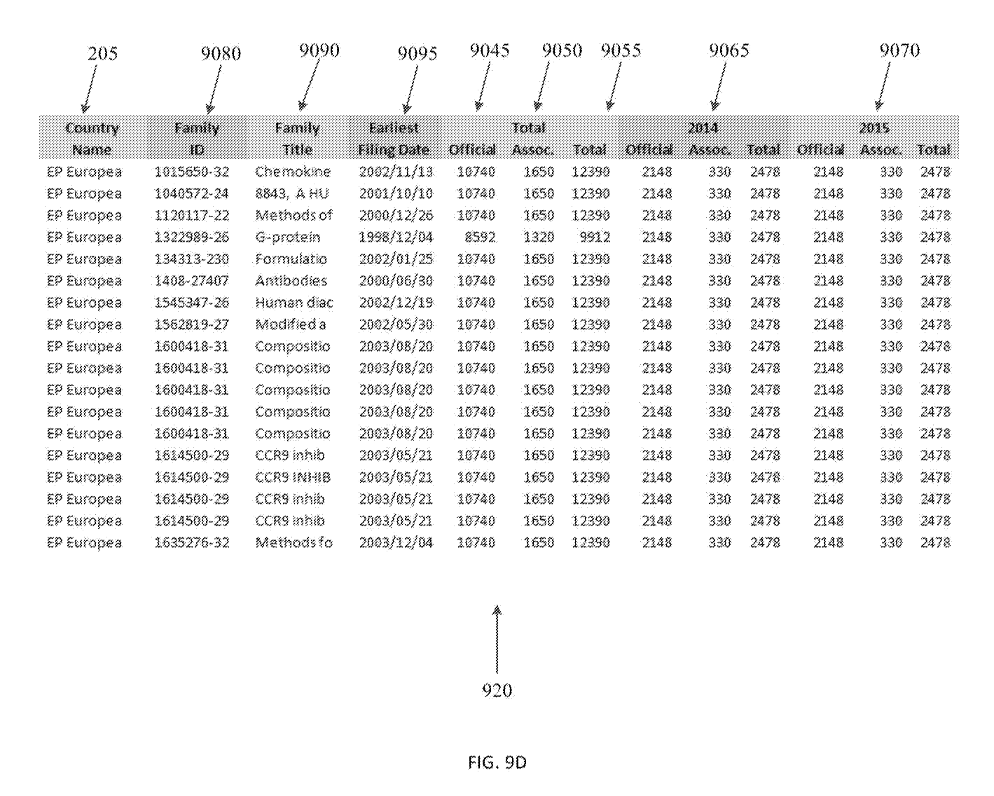

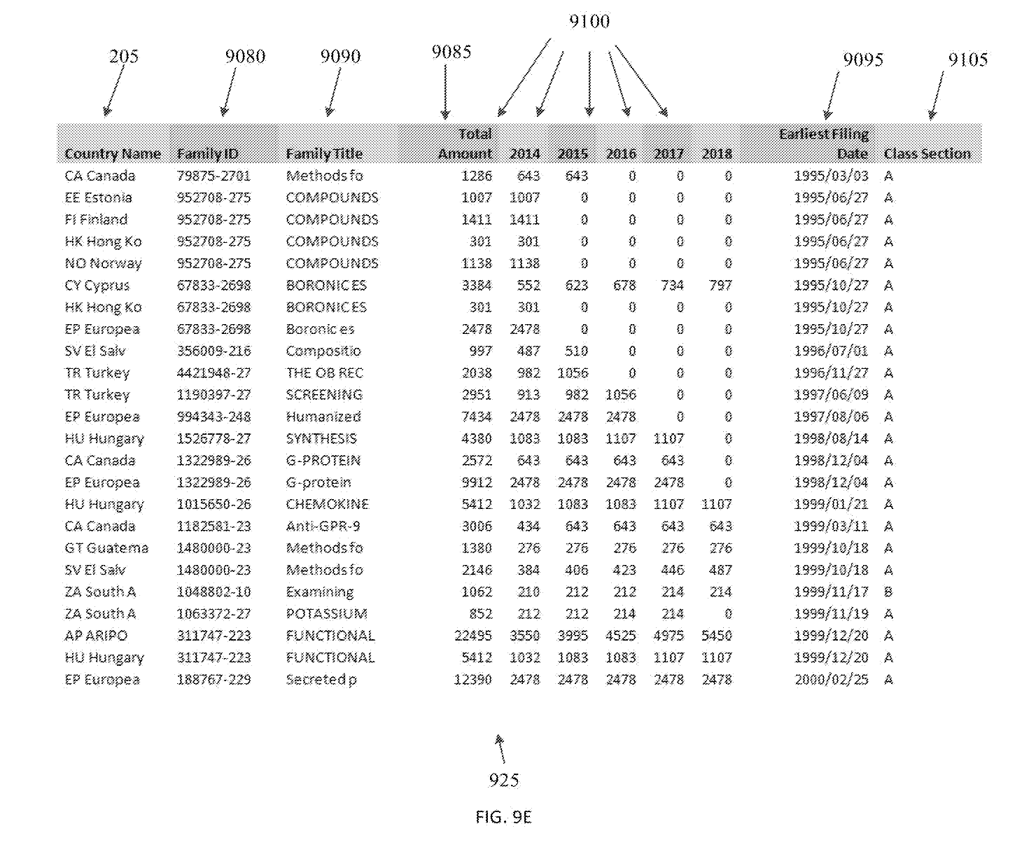

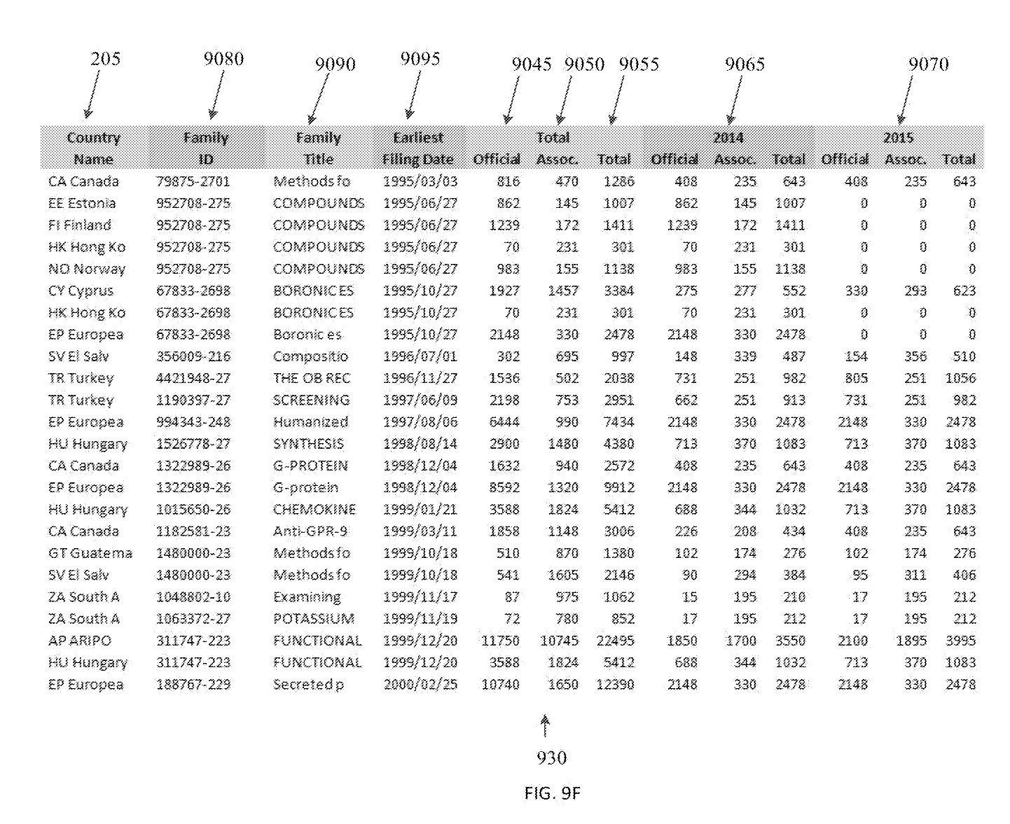

FIGS. 9 and 9A-9F illustrate an exemplary analysis report of Ungranted Patent Applications, in accordance with an embodiment of the present invention, in which FIG. 9A is an illustration of an Ungranted Aging Report Summary, FIG. 9B is an illustration of an Ungranted Aging Report Category Summary, FIG. 9C is an illustration of an Ungranted Aging Report Detail, FIG. 9D is an illustration of an Ungranted Aging Report Category Detail, FIG. 9E is an illustration of an Ungranted Aging Report Detail by Family, and FIG. 9F is an illustration of the Ungranted Aging Report Category Detail by Family. In the present embodiment, the software may output various calculated and analysis reports into a spreadsheet, including, without limitation, an Ungranted Patent Application 900 that includes, without limitation, the following five tabs: summary 905, category summary 910, detail 915, category detail 920, detail by family 925, and category detail by family 930. In the present embodiment, the summary 905 report tab lists the total maintenance amount to be paid 9010, in, without limitation, descending order by country 205, in addition to the total count of patents involved 9015, the maintenance costs by year beginning in year 2014 9020, in year 2015 9025, in year 2016 9030, in year 2017 9035, and the maintenance costs in year 2018 9040. In a non-limiting example, the software may locate those ungranted applications that may have not been granted ‘X’ years beyond the typical time to grant for a given country. In the present non-limiting example, X may be for example, but not limited to, three years. Further, in the present non-limiting example, reports may accumulate yearly maintenance payments for each such application. In some alternate embodiments, the reports may sorted, as in a non-limiting example, in a descending order for a selected year.

In the present embodiment, the category summary 910 report tab may be further broken down into category totals, which may include, without limitation, country name 205, the total count of patents involved 9015, official fees 9045, local associate charges 9050, the summation of both the official fees and local charges 9055, and total amount of costs and/or fees broken down by year, 2014 9060, and 2015 9065.

In the present embodiment, the detail 915 report tab identifies the particular ungranted applications whose maintenance costs are totaled to generate the Ungranted Aging Report Summary report 900. Further, in the present embodiment, the rows in this detail report 915 are grouped, without limitation, by the country name 205 to match the order in the Ungranted Aging Report Summary report 900. Additionally, within the present embodiment, the country 205 rows are sorted by Family ID 9080. Further, in the present embodiment, each row contains, without limitation, the maintenance costs 9085 as described in totality in the Ungranted Aging Report Summary 900, as well as patent application information, including, without limitation, the Family Title 9090, Family ID 9080, the earliest filing date within the family 9095, future maintenance costs 9100, and the classification group 9105.

Moreover, in the present embodiment, category detail 920 report tab, may further break down, without limitation, category details into category totals for Official fees 9045, local Associate costs 9050, and the summation of both the official fees and local charges 9055.

Further, in the present embodiment, detail by family 925 report tab identifies the particular ungranted applications whose maintenance costs 9010 are totaled to generate the Ungranted Aging Report Summary report 900. Additionally, in the present embodiment, the rows in this report 925 are grouped by Patent Family 9090 and, without limitation, the Patent Families 9090 are reported in order of earliest filing date of any application within the family 9095. Further, in the present embodiment, each country 205 within the family has a row, containing the maintenance costs 9085 as described for the Ungranted Aging Report Summary report 900, as well as patent-application information, including, without limitation, Family ID 9080 and Earliest Filing within the Family 9095, future maintenance costs 9100, and classification group 9105.

In the present embodiment, category detail by family 930 report tab further breaks down the Detail by Family 925 into Category totals: Official fees 9045, local Associate costs 9050, total 9055, and future years 9065 for 2014 and 9070 for 2015.

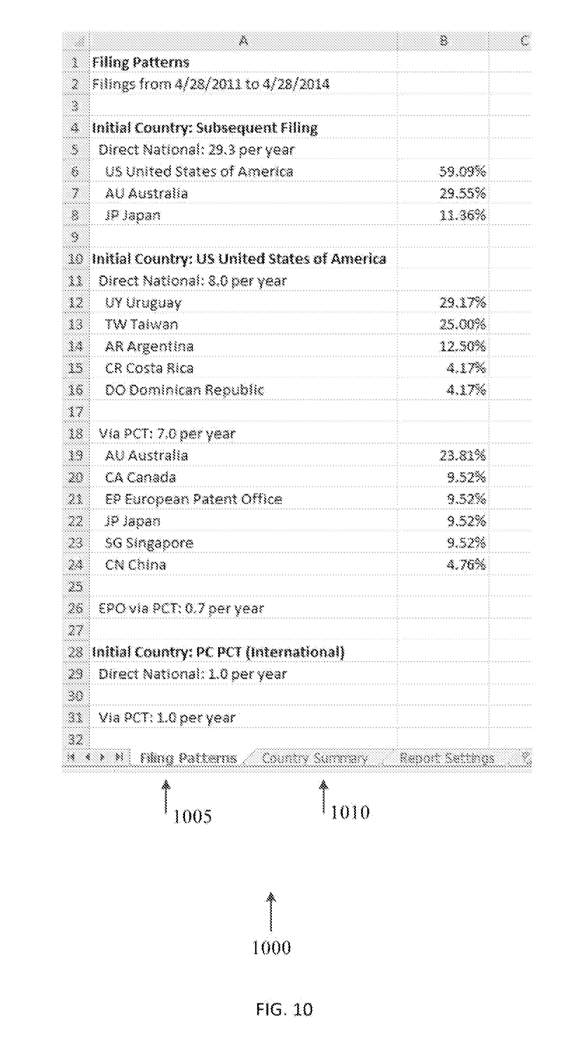

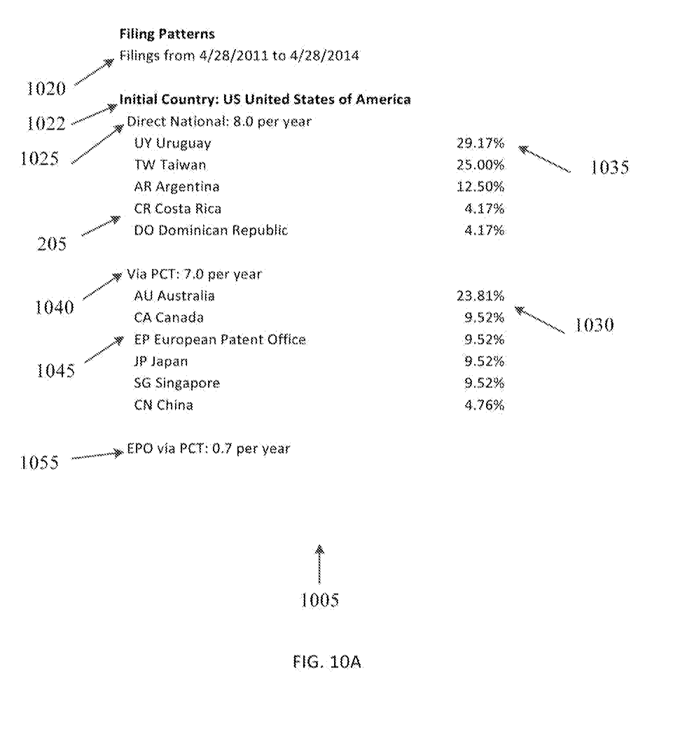

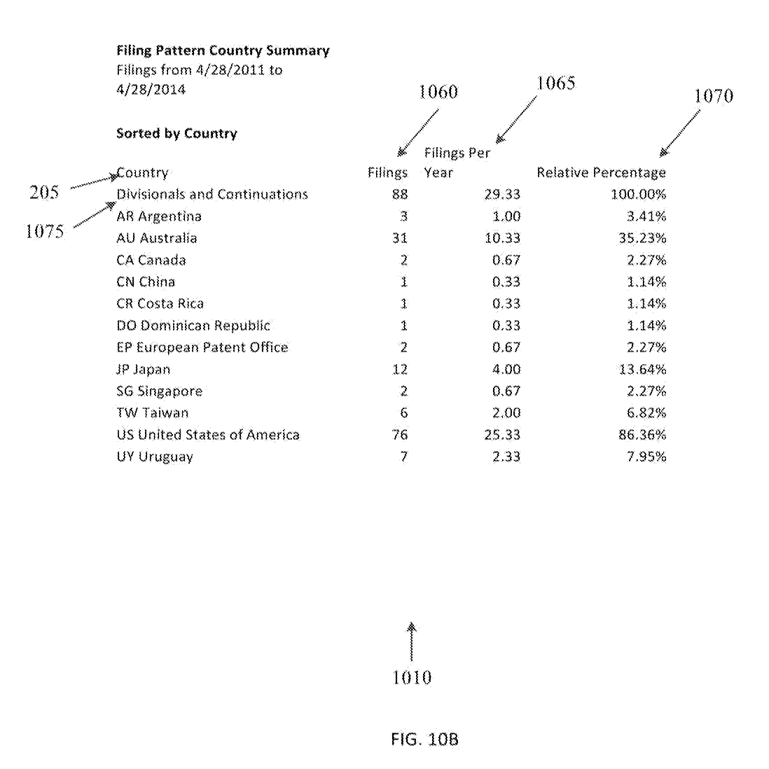

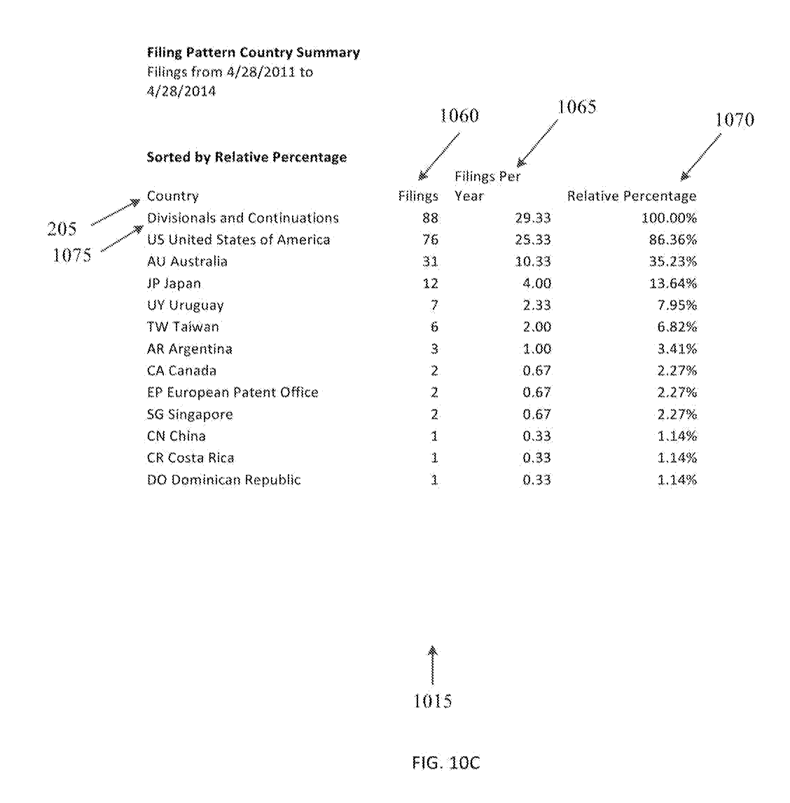

FIGS. 10 and 10A-10C illustrate an exemplary analysis report of filing patterns in patent applications, in accordance with an embodiment of the present invention, in which FIG. 10A is an illustration of a Filing-Patterns Report, FIG. 10B is an illustration of a Filing-Patterns-Analysis Country-Summary Report (sorted by country), and FIG. 10C is an illustration of a Filing-Patterns-Analysis Country-Summary Report (sorted by relative percentage), in accordance with an embodiment of the present invention. In the present embodiment, the software may analyze patent applications filed in any specified range of dates and output filing-pattern analysis 1000 data in a spreadsheet that comprises two report tabs: filing patterns 1005 and country summary 1010. FIG. 10A illustrates a sampling of information in filing patterns 1005. Further, in the present embodiment, the filing pattern 1005 report tab, for a given period 1020, may determine each possible initial country for filing 1022. In the present embodiment, the filing pattern 1005 may determine an average number of times per year such an initial application was filed in 1025. Additionally, the present embodiment may determine countries 205 where the initial applications were subsequently filed directly as national applications and percentages of times to each country 205 for the subsequently filed applications. Additionally, the present embodiment may determine how many subsequent applications were filed the PCT each year on average 1040, and shows the countries 1045, with associated percentages 1030, via the PCT. Additionally, the present embodiment may determine how many subsequent applications there were to the EPO, or EPO via PCT, each year on average 1055, and may determine the countries, with associated percentages, via the EPO. Additionally, the present embodiment may determine how many Continuation/Divisional applications 1075 were filed on average per year, and shows the countries, along with associated percentages In some embodiments, the filing pattern report 1005 may be determined by a selected filing date range. In a non-limiting example, if filing pattern report 1005 is based on a filing date range, then determined results may be shown in sets, with one set for ‘All dates’, next for ‘Date range 1’, next for ‘Date range 2’, etc. In other alternate embodiments, the filing report 1005 may include abandoned applications. In a non-limiting example, columns may include, without limitation, ‘% filings abandoned’; ‘average time to abandonment’; ‘median time to abandonment’. In another alternate embodiments, the filing report 1005 may include granted applications. In a non-limiting example, columns may include, without limitation, ‘% filings granted’; ‘average time to grant’; ‘median time to grant’.

In the present embodiment, the country summary 1010 report tab may be sorted by country or, by relative percentage 1015. In some embodiments, each country shows the number of applications filed in that country regardless of the route chosen for filing. In some alternate embodiments, each country may show percentages of routes of filing such as, but not limited to, direct filing, PCT, EPO. Further, in the present embodiment, the country summary 1010 and 1015 report tabs may show countries the filed 205, the number of filings 1060, the average filings per year 1065, and the relative percentage of such filings (i.e. relative to the total number of filings) 1070. In many embodiments, the filing report may provide a quick but comprehensive view of country filing strategies, providing, in condensed form, key data elements such as, but not limited to, countries that have been considered important, filing routes chosen, frequency of applications to various countries, a frequency of applications to various countries, a variation of these strategies over time, an abandonment strategy being used, and a view of grant percentages in various countries. By reviewing such information for the analyst's own company, future actions may be better informed. By reviewing such information for competitors, future actions may be better informed.

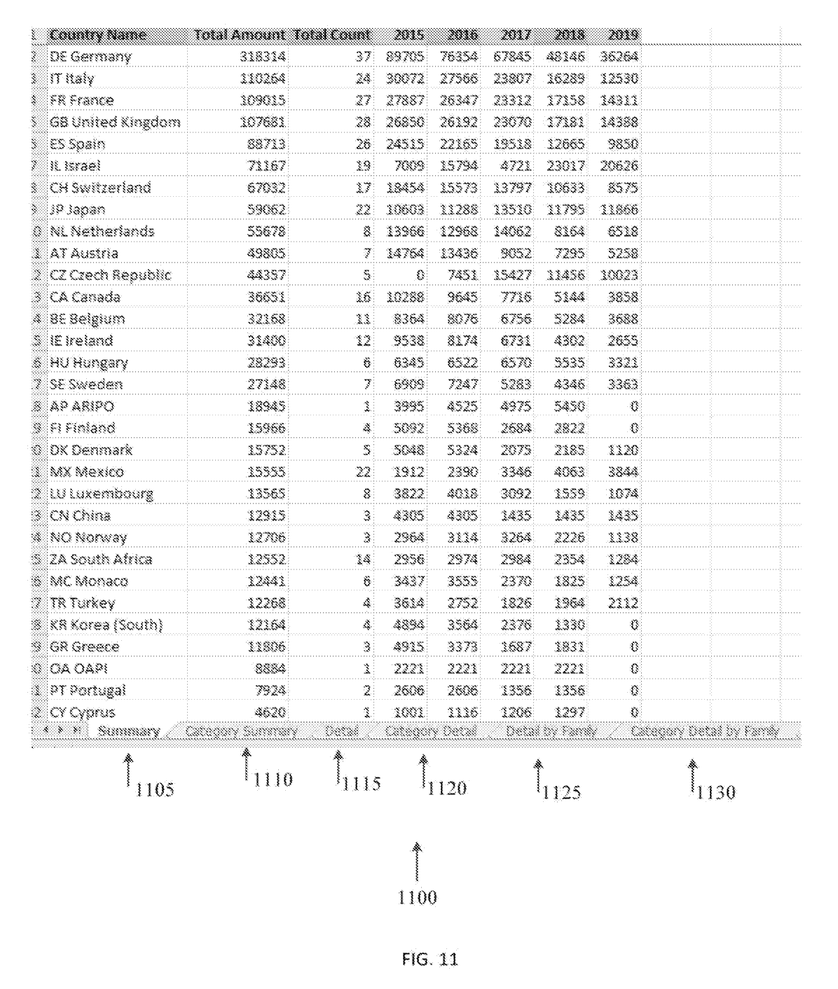

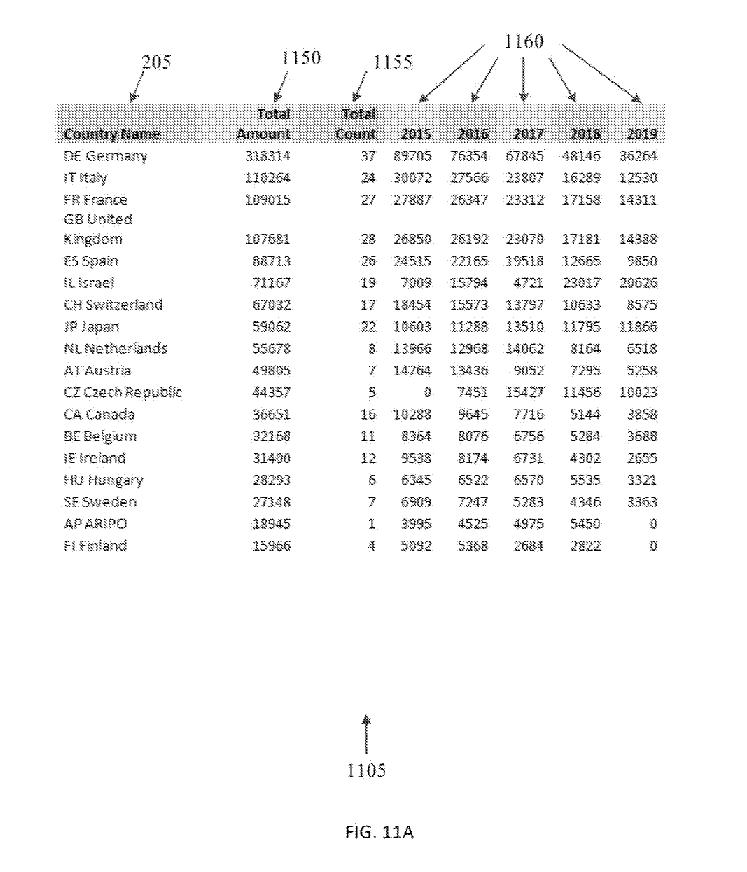

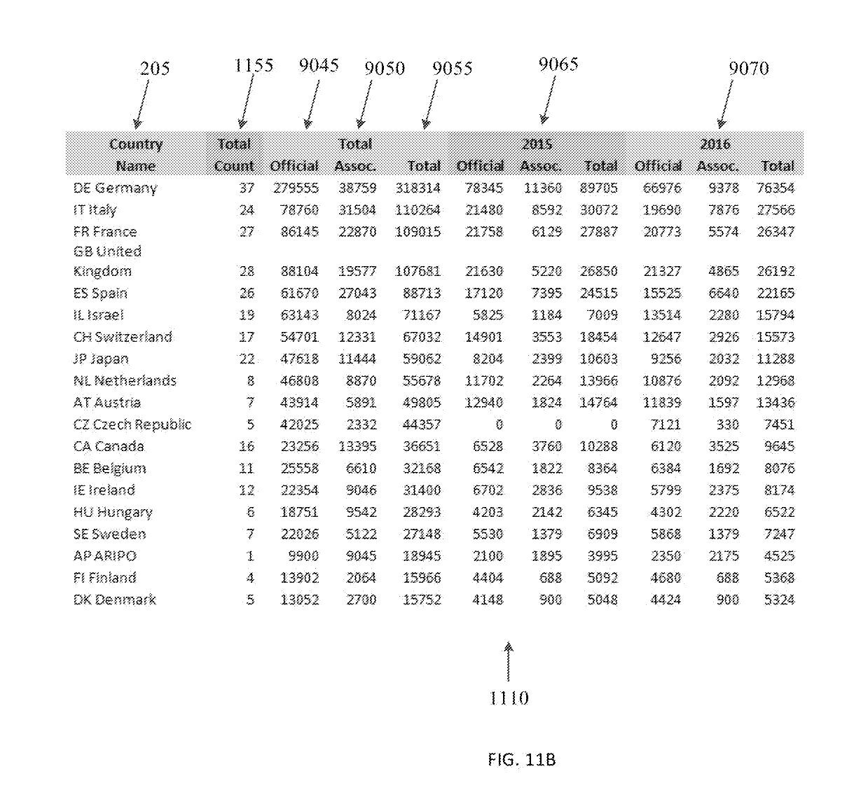

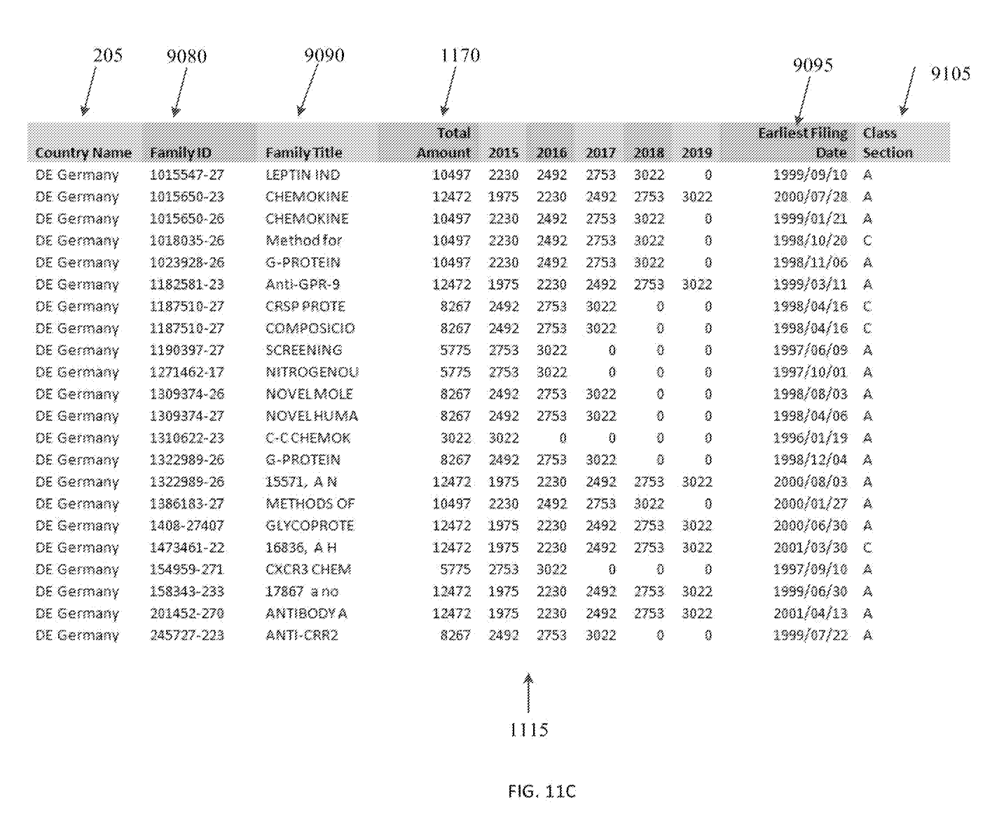

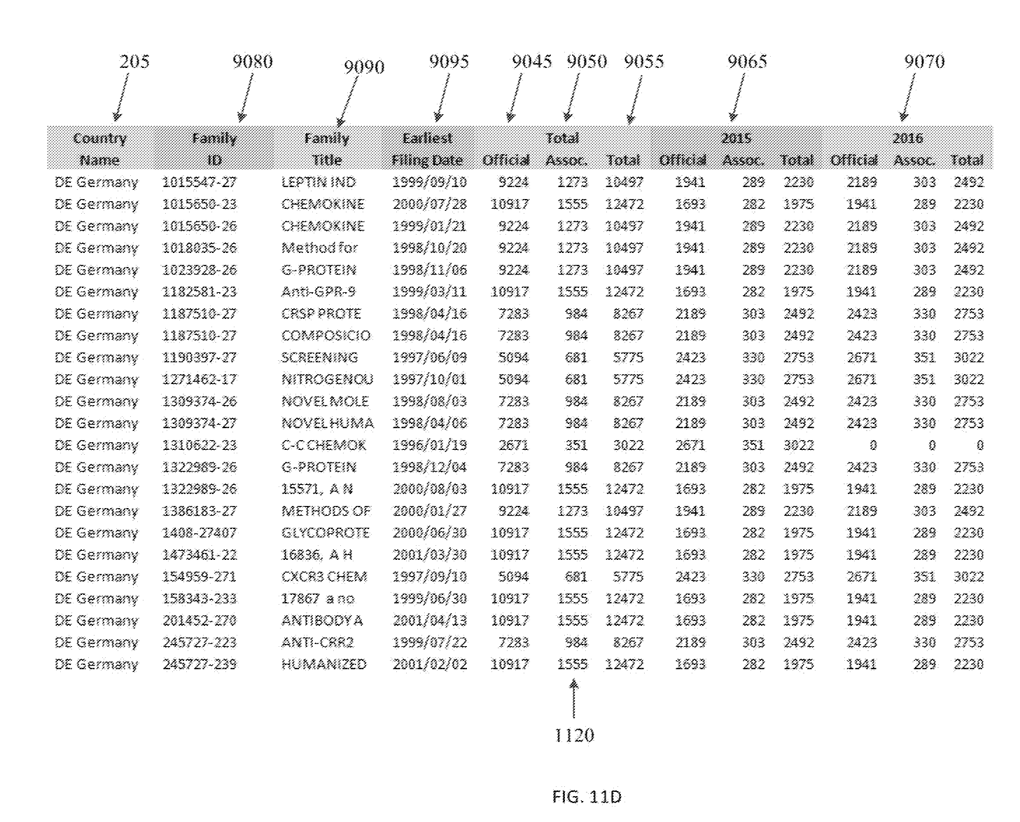

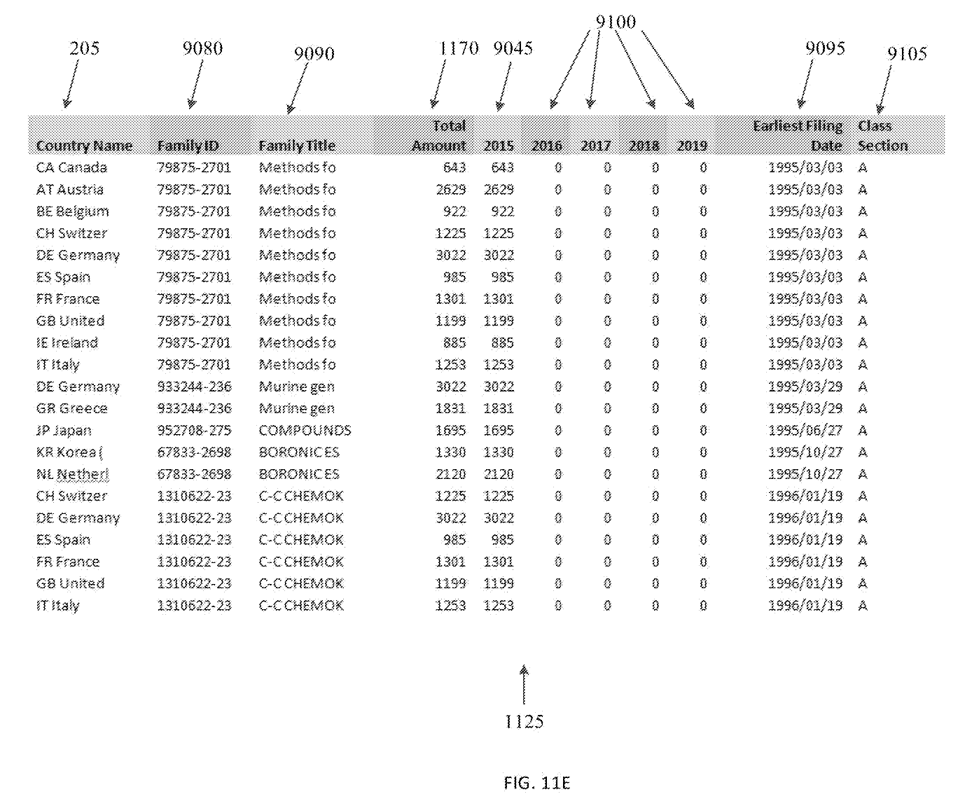

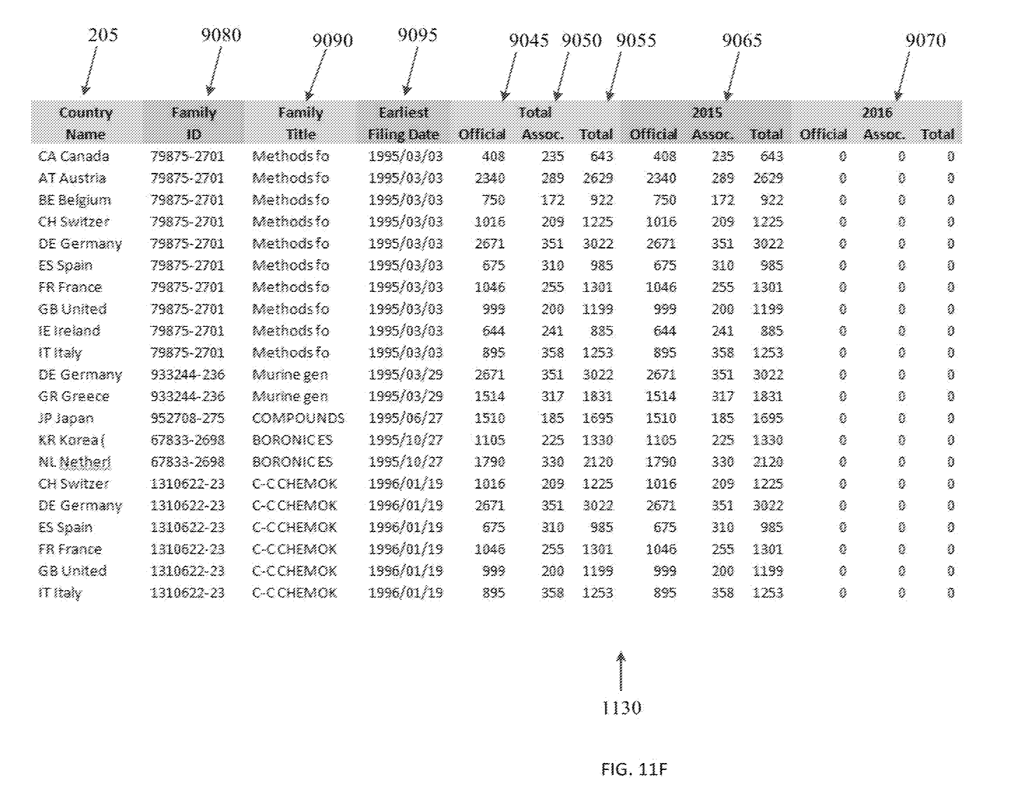

FIGS. 11 and 11A-11F illustrate an exemplary analysis report of expiring patent applications, in accordance with an embodiment of the present invention, in which FIG. 11A is an illustration of an Expiring-Patents Report Summary, FIG. 11B is an illustration of an Expiring-Patents Report Category Summary, FIG. 11C is an illustration of an Expiring-Patents Report Detail, FIG. 11D is an illustration of an Expiring-Patents Report Category Detail, FIG. 11E is an illustration of an Expiring-Patents Report Detail by Family, and FIG. 11F is an illustration of an Expiring-Patents Report Category Detail by Family, in accordance with an embodiment of the present invention. In the present embodiment, the software may analyze and generate a report of maintenance costs associated with patents due to expire in ‘X’ number of years. In a non-limiting example, ‘X’ is 5 years. In the present embodiment, the Expiring-Patents Report Summary 1100 may be displayed as a spreadsheet that may include, without limitations, one or more groups of the following tabs: report summary 1105, category summary 1110, detail 1115, category detail 1120, report detail by family 1125, and the category detail by family 1130. Further, in the present embodiment, the summary 1105 report tab may be sorted by total maintenance costs to be paid in the next ‘X’ years 1150, contains the totals for each country 205, the number of patents 1155, and the costs of expiring patents in future years 1160. In a non-limiting example, expiring patents may be sorted in decreasing order of totals for a country, and the summary 1105 report tab may also show the count of such patents in each country.

In the present embodiment, the category summary 1110 report tab may break down amounts for each country into official fees 9045, associate costs 9050, the summation of fees and costs 9055, and future total fees 9065 for 2015 and 9070 for 2016.

In yet another embodiment, the detail 1115 report tab identifies the particular granted patents whose maintenance costs are totaled 1170 to generate the summary 1105 report tab. In the present embodiment, the rows in this report are grouped by country 205 in the same order as the summary 1105 report tab; however, within the country 205, the rows are sorted by Family ID 9080, where each row contains the maintenance costs 1170 as described for the summary 1105 report tab, as well as patent-application information, such as family title 9090, earliest filing date within the family 9095, and classification group 9105. In a non-limiting example, the detail 1115 report tab may enable a patent-by-patent review in each applicable country 205 and may be sorted by Family ID 9080 within each country 205.

In the present embodiment, the category-detail 1120 report tab may show detail amounts broken down by official fees 9045 and/or associate charges 9050.

In the present embodiment, the report detail by family 1125 tab identifies the particular granted patents whose maintenance costs are totaled 1170 to generate the summary 905 report tab and in which the rows are grouped by patent family 9080. In the present embodiment, the patent families 9080 are reported in order of earliest filing date 9095 of any application within the family. Further, in the present embodiment, each country 205 within the family 9080 has a row that contains the maintenance costs 1170, as described for the Summary report 905, as well as patent-application information such as, but not limited to, Family ID 9080, Family Title 9090, future maintenance costs 9100, earliest filing within the family 9095, and classification 9105.

In the present embodiment, the report category detail by family 1130 is the Detail by Family 1125 further broken down into category totals, which may include without limitation, Official fees 9045, Associate costs 9050, and the summation of both 9055.

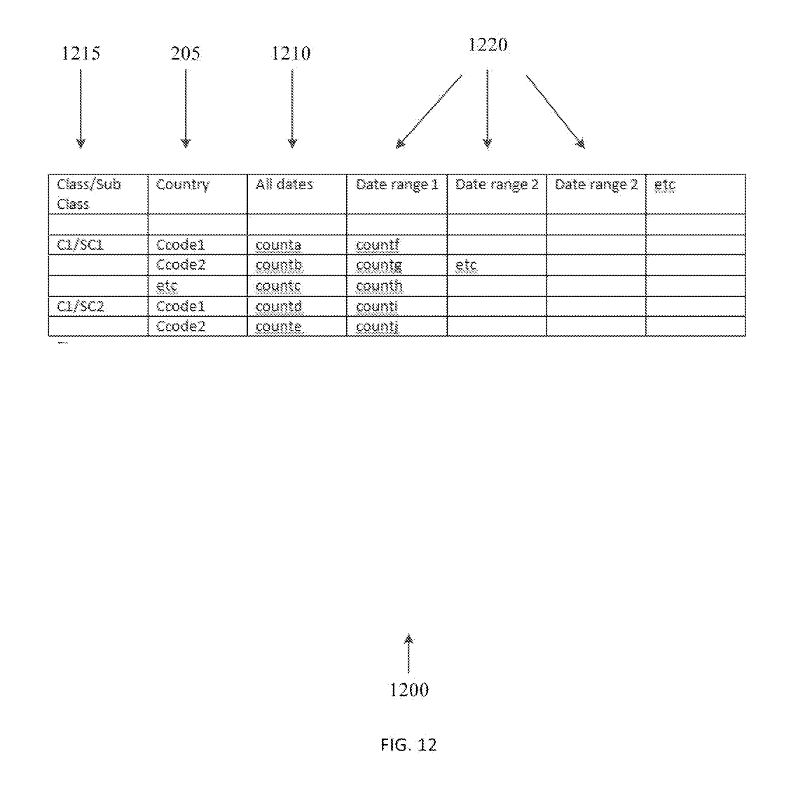

FIG. 12 is an illustration of an exemplary analysis report of the classification of patent applications, in accordance with an embodiment of the present invention. In the present embodiment, the software may generate a variety of reports that show various calculated data including, without limitation, an application-classification report 1200. In a non-limiting example, the application-classification report 1200 may be sorted by country or by counts in any column. In the present embodiment, an application classification report 1200 may show the country of application 205, the total count of filing for all date ranges 1210, and the class and sub-class codes 1215. In a non-limiting example, class may be the ‘International Patent Classification (IPC)’ system. In another non-limiting example, the application-classification report 1200 identifies where filings are being done by Class/Sub-class and date range, which allows the analyst to identify trends over time, identify areas of filing concentration, identify competitors' areas of filing concentration and variations which may guide strategic decisions in novel or more informed ways. In the present embodiment, the data may be collected from a specified date range 1220.

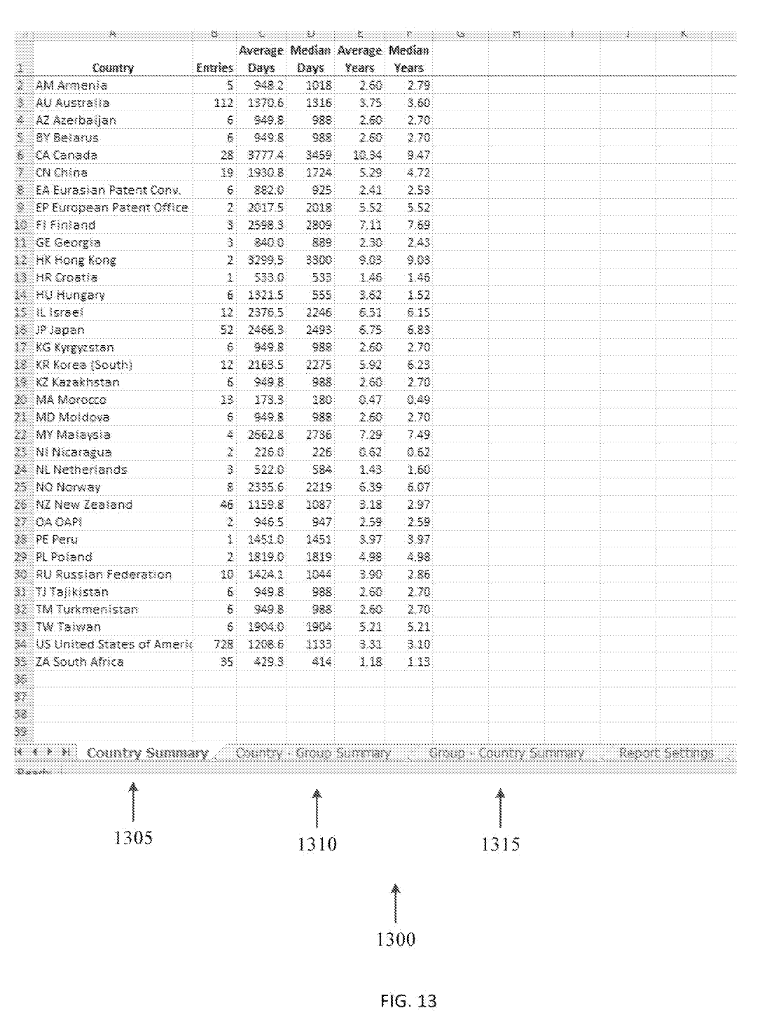

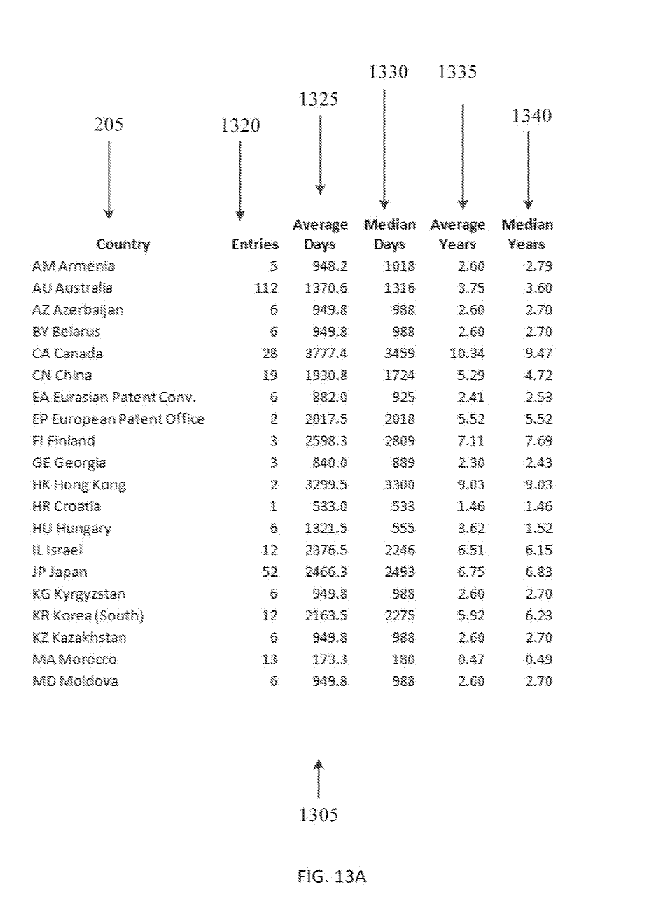

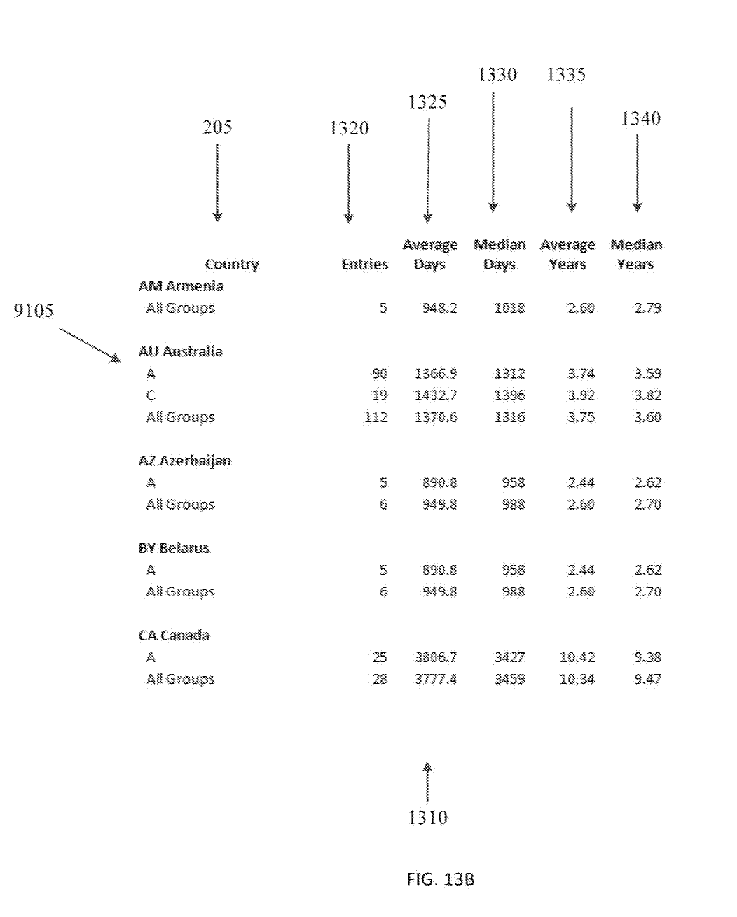

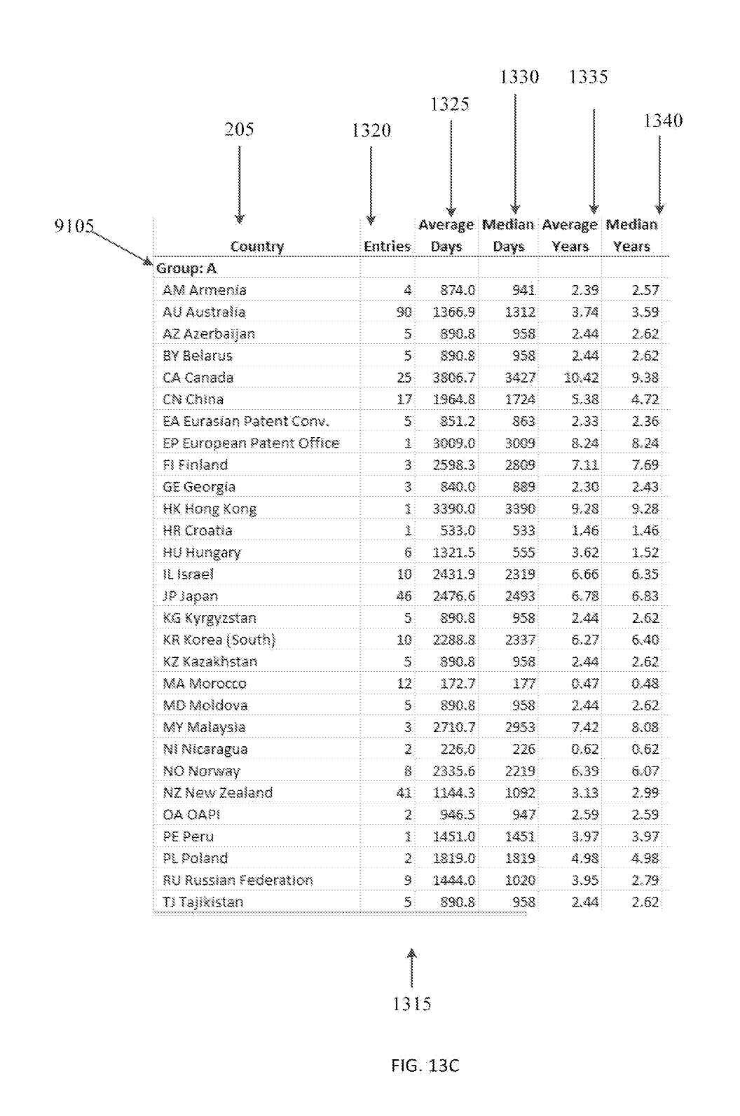

FIGS. 13 and 13A-13C illustrate an exemplary analysis report of the time to grant patent applications, in accordance with an embodiment of the present invention, in which FIG. 13A is an illustration of a Time to Grant Analysis, by country, FIG. 13B is an illustration of a Time to Grant Analysis, first by country and then by the classification group of applications within the country, and FIG. 13C is an illustration of a Time to Grant Analysis, first by classification group and then by country in accordance with an embodiment of the present invention. In the present embodiment, the software may generate a time-to-grant analysis spreadsheet 1300, which may include, without limitation, three tabs: country summary 1305, country-group summary 1310, and the group-country summary 1315. The present embodiment, the country summary 1305, report tab sorted by country 205, gives the number of patent entries 1320, the average number of days before patents are granted 1325, the median number of days before patents are granted 1330, the average years 1335, and the median years 1340.

In the present embodiment, the country-group summary 1310 report tab sorted by country 205 and classification group 9105, gives the number of patent entries 1320, the average number of days before patents are granted 1325, the median number of days before patents are granted 1330, the average years 1335, and the median years 1340.

The present embodiment, the group-country summary 1315 report tab sorted by classification group 9105, gives the number of patent entries 1320, the average number of days before patent are granted 1325, the median number of days before patent are granted 1330, the average years 1335, and the median years 1340.

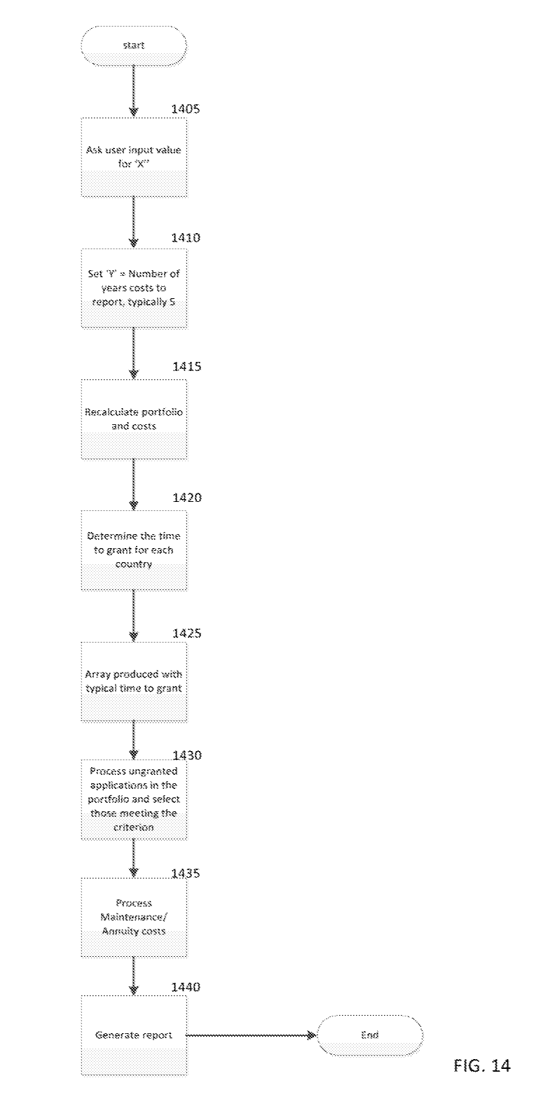

FIG. 14 is an illustration of an exemplary method for generating Ungranted Aging Report, in accordance with an embodiment of the present invention. In the present exemplary embodiment shown, in a step 1405, the software prompts the user to input a value for ‘X’, which is the number of years beyond the typical time period that patents are granted in the applicant's country. In a non-limiting example, ‘X’ typically is entered as three years beyond the typical time period that patents are granted in the applicant's country. After the user inputs the ‘X’ value, the software will, in a step 1410 ask the user to set the ‘Y’ value equal to the number of years of costs to report. In a non-limiting example, the typical ‘Y’ value is five years. The software will recalculate portfolio dates and costs, at a step 1415 with the “time to grant” temporarily set to 25 years for all countries, as well as the “randomize grant dates” set to off. In a non-limiting example, may ensure that any calculated grant date, as opposed to known actual grant dates, are after the report period. The software will now need to determine the time to grant for each country, at a step 1420 to use as a basis for deciding whether the application remains ungranted for an unusually long period. The software will produce an array, at a step 1425 with the Typical Time to Grant for each country. The software will process ungranted applications, at a step 1430 and based, without limitation, on the following formula: (Now−Application Filing date)>=(‘Typical Time to Grant’+X years). The software will search the portfolio and select those that meet the criterion and, at a step 1435 only process Maintenance/Annuity costs. Finally, the software will produce the report, at a step 1440, without limitation, as referenced in FIG. 9.

In accordance with the teaching of present invention, one of ordinary skill will readily realize that data in the spreadsheets may be formatted or sorted in a variety of ways. In some alternate embodiments, the spreadsheets may include additional information determined during the processing of the data. In some alternate embodiments, additional information may be included in the spreadsheets as hidden columns or rows where the user may choose to unhide the data columns or rows. In some other alternate embodiments, the spreadsheets may include a macro type program to assist the user in performing operations on the spreadsheets such as, but not limited to, sorting, formatting, searching, and further analysis.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: web site hosting and cloud storage for databases.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing data analysis into customizable detailed reports according to the present invention will be apparent to those skilled in the art. Various aspects of the invention have been described above by way of illustration, and the specific embodiments disclosed are not intended to limit the invention to the particular forms disclosed. The particular implementation of the data analysis may vary depending upon the particular context or application. By way of example, and not limitation, the detailed reports as described in the foregoing were principally directed to patent portfolio implementations and to assist analyst's and/or managers in making quantitative decisions regarding said patent portfolio; however, similar techniques and reports may instead be applied to portfolios consisting of any available data which may include, without limitation, a stock portfolio to which a customized report may be useful to an analyst or manager, and in which the implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method comprising the steps of:
transmitting, over a network to a server, a user's request for a report, said request comprising at least a name associated with a portfolio of intellectual property comprising at least patent applications, a first value indicating a time frame, and a second value indicating a period of time, said server being configured to be operable for: using at least said name for extracting patent application data from one or more first set of databases to a second database; filtering said extracted patent application data using said first value; organizing said filtered patent application data by at least offices of filing, patent families, classifications, and status; determining costs for patent applications associated with said filtered patent application data using at least said second value; determining filing patterns using at least said offices of filing and said patent families; determining filing activity using at least said classifications; determining times to grant for said offices of filing; and generating at least one report according to said user's request; and
receiving, over the network from said server, said at least one report for said portfolio.

2. The method as recited in claim 1, in which said at least one report comprises maintenance costs for patent applications having a status of ungranted.

3. The method as recited in claim 1, in which said at least one report comprises filing patterns comprising at least filing routes and percentages filing routes, initial offices, and abandonments.

4. The method as recited in claim 1, in which said at least one report comprises maintenance costs for patent applications having a status of expiring.

5. The method as recited in claim 1, in which said at least one report comprises filing activities grouped by classification.

6. The method as recited in claim 1, in which said at least one report comprises projected times to grant for patent applications having a status of ungranted.

7. The method as recited in claim 1, in which said at least one report comprises at least a summary section and a detailed section.

8. The method as recited in claim 7, in which said at least one report comprises a spreadsheet format.

9. The method as recited in claim 8, in which said spreadsheet format comprises separate tabbed sections for said at least summary section and detailed section.

10. A system comprising:
a client communicating over a network a user's request for a report, said request comprising at least a name associated with a portfolio of intellectual property comprising at least patent applications, a first value indicating a time frame, and a second value indicating a period of time; and
a server in communication with said client, said server being configured to be operable for: using at least said name for extracting patent application data from one or more first set of databases to a second database; filtering said extracted patent application data using said first value; organizing said filtered patent application data by at least offices of filing, patent families, classifications, and status; determining costs for patent applications associated with said filtered patent application data using at least said second value; determining filing patterns using at least said offices of filing and said patent families; determining filing activity using at least said classifications; determining times to grant for said offices of filing; and generating at least one report according to said user's request; and communicating to said client at least one report for said portfolio.

11. The system as recited in claim 9, in which said at least one report comprises a plurality of reports having at least a summary section and a detailed section in tabbed sections of a spreadsheet format, said plurality of reports at least comprising maintenance costs for patent applications having a status of ungranted, filing patterns comprising at least filing routes and percentages filing routes, initial offices, and abandonments, filing patterns comprising at least filing routes and percentages filing routes, initial offices, and abandonments, filing activities grouped by classification, and projected times to grant for patent applications having a status of ungranted.

12. A non-transitory computer-readable storage medium with an executable program stored thereon, wherein the program instructs one or more processors to perform the following steps:
transmitting, over a network to a server, a user's request for a report, said request comprising at least a name associated with a portfolio of intellectual property comprising at least patent applications, a first value indicating a time frame, and a second value indicating a period of time, said server being configured to be operable for: using at least said name for extracting patent application data from one or more first set of databases to a second database; filtering said extracted patent application data using said first value; organizing said filtered patent application data by at least offices of filing, patent families, classifications, and status; determining costs for patent applications associated with said filtered patent application data using at least said second value; determining filing patterns using at least said offices of filing and said patent families; determining filing activity using at least said classifications; determining times to grant for said offices of filing; and generating at least one report according to said user's request; and
receiving, over the network from said server, said at least one report for said portfolio.

13. The program instructing the processor as recited in claim 12, in which said at least one report comprises maintenance costs for patent applications having a status of ungranted.

14. The program instructing the processor as recited in claim 12, in which said at least one report comprises filing patterns comprising at least filing routes and percentages filing routes, initial offices, and abandonments.

15. The program instructing the processor as recited in claim 12, in which said at least one report comprises maintenance costs for patent applications having a status of expiring.

16. The program instructing the processor as recited in claim 12, in which said at least one report comprises filing activities grouped by classification.

17. The program instructing the processor as recited in claim 12, in which said at least one report comprises projected times to grant for patent applications having a status of ungranted.

18. The program instructing the processor as recited in claim 12, in which said at least one report comprises at least a summary section and a detailed section.

19. The program instructing the processor as recited in claim 18, in which said at least one report comprises a spreadsheet format.

20. The program instructing the processor as recited in claim 19, in which said spreadsheet format comprises separate tabbed sections for said at least summary section and detailed section.
